(19) United States
(12) Patent Application Publication
(10) Pub. No.: US 2025/0305974 A1
(43) Pub. Date: Oct. 2, 2025

(54) TECHNIQUES FOR AUTOMATICALLY MEASURING CELL TYPE BASED ON IMPEDANCE

(71) Applicant: Rutgers, The State University of New Jersey, New Brunswick, NJ (US)

(72) Inventors: Mehdi JAVANMARD, Princeton Junction, NJ (US); Gulam Mohmad RATHER, New Brunswick, NJ (US); Mahtab KOKABI, North Brunswick, NJ (US)

(21) Appl. No.: 19/090,597

(22) Filed: Mar. 26, 2025

Related U.S. Application Data
(60) Provisional application No. 63/569,862, filed on Mar. 26, 2024.

(51) Int. Cl. G01N 27/02; G01N 35/00

(52) U.S. Cl. CPC G01N 27/028; G01N 35/00584; G01N 2035/00633

(57) ABSTRACT

Techniques for automatically measuring cell type based on electrical impedance includes single cell type or population cell types. Imaging a single cell includes measuring impedance time series while a single cell traverses a gap between a pair of electrodes in a microfluidic channel. A virtual image of the single cell is generated using a trained neural network and the measured impedance time series. Each training instance includes impedance time series of a training instance cell and a microscopic image of the cell. Automatically determining cell type of a population includes measuring population impedance time series while multiple cells of a sample traverse the gap. A measured probability density function (PDF) of amplitudes of isolated extrema in the population is generated. A first cell type in the sample is determined automatically based on the measured PDF and a database storing a PDF for each cell type of multiple cell types.

### CROSS-REFERENCE TO RELATED APPLICATIONS

This application claims benefit of Provisional Appln. 63/569,862, filed Mar. 26, 2024, the entire contents of which are hereby incorporated by reference as if fully set forth herein, under 35 U.S.C. § 119 (e).

### STATEMENT OF GOVERNMENTAL INTEREST

This invention was made with government support under grants 1846740 and 2002511 awarded by the National Science Foundation. The government has certain rights in the invention.

### BACKGROUND

Cell typing includes the imaging or identification of biological cells derived from an organism, or both. Traditional methods often struggle with the automatic determination of cell types without bulky and complex microscopic equipment.

### SUMMARY

Techniques are provided for automatically measuring cell type based on impedance sensing.

In a first set of embodiments, a method for imaging a single cell includes measuring single cell impedance observation data that indicates a time series of impedance measurements during an observation time in which a single biological cell traverses a first gap between a first pair of electrodes in a first microfluidic channel. The method also includes generating a virtual image of the single cell based on the single cell impedance observation data using a neural network trained on multiple training instances. Each training instance includes single cell impedance observation data for a training instance single biological cell and a microscopic image of the training instance single biological cell. The method further includes presenting the virtual image of the single cell on a display device.

In some embodiments of the first set, the microscopic image of the training instance single biological cell is a single frame of a microscopic video viewing a second gap between a second pair of electrodes in a second microfluidic channel as the training instance single biological cell traverses the second gap to obtain the single cell impedance observation data for the training instance single biological cell. In some of these embodiments, the first gap between the first pair of electrodes in the first microfluidic channel is also the second gap between the second pair of electrodes in the second microfluidic channel.

In a second set of embodiments, a method for automatically determining cell type of a population of biological cells in a sample includes measuring population impedance observation data that indicates a time series of impedance measurements during a population observation time in which multiple biological cells of a sample traverses a first gap between a first pair of electrodes in a first microfluidic channel. The method also includes generating a measured probability density function of amplitudes of isolated extrema in the population impedance observation data for the sample. Still further, the method includes automatically determining a first cell type in the sample based on the measured probability density function and a database storing a probability density function of amplitudes of isolated extrema in impedance training data for each cell type of multiple cell types. Even further still, the method includes presenting the first cell type.

In some embodiments of the second set, the method even further still includes determining a first portion of the sample contributed by the first cell type. In these embodiments, the method yet further includes presenting the first portion contributed by the first cell type.

In other sets of embodiments, a non-transient computer-readable medium or an apparatus or a system is configured to perform one or more steps of the above methods.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings, in which, like reference numerals refer to similar elements and in which:

FIG. 1A is a block diagram that illustrates an example of a training set, according to an embodiment;

FIG. 1B is a block diagram that illustrates an example of a method for training a model by setting model parameters based on the training set, according to an embodiment;

FIG. 2A is a block diagram that illustrates an example of a neural network for illustration, according to an embodiment;

FIG. 2B is a plot that illustrates examples of activation functions used to combine inputs at any node of a feed forward neural network, according to various embodiments;

FIG. 3A through FIG. 3C are block diagrams and a photograph, respectively, that illustrate an example of a system for making and using impedance measurements of biological cells at multiple frequencies, according to various embodiments;

FIG. 4A and FIG. 4B are plots that each illustrate examples of impedance measurements time series at a single frequency, according to an embodiment;

FIG. 5 is a photograph of an example of a system for making simultaneous impedance and video measurements of biological cells for training an example neural network, according to an embodiment;

FIG. 6 is a set of examples of images captured by the system of FIG. 5 for training the neural network, according to an embodiment;

FIG. 7A is a block diagram that illustrates use of the neural network after training, according to an embodiment;

FIG. 7B is a listing of image similarity during validation testing of the neural network indicating good performance, according to an embodiment;

FIG. 8 is a flow chart that illustrates an example method to train and use a neural network for single cell imaging based on impedance, according to an embodiment;

FIG. 9A through FIG. 9C are block diagrams that illustrate examples of populations of different cell types to distinguish using impedance measurements, according to an embodiment;

FIG. 10A and FIG. 10B are plots that illustrate examples of population impedance observations, for which amplitudes of extreme deviations from background (extrema) are characterized by probability density functions, according to an embodiment;

FIG. 11A is a plot that illustrates examples of the distributions of extrema amplitudes for different cell types, according to an embodiment;

FIG. 11B is a plot that illustrates examples of differences in distribution of adherent and suspended cell lines for a first type of breast cancer, according to an embodiment;

FIG. 11C is a plot that illustrates examples of non-normalized probability density functions of the distributions depicted in FIG. 11B, according to an embodiment;

FIG. 11D and FIG. 11E correspond to FIG. 11B and FIG. 11C, respectively, but for a second type of breast cancer, according to an embodiment;

FIG. 12 is a flow chart that illustrates an example method to train and use probability density functions for different cell types in analyzing population impedance extrema from a sample, according to an embodiment;

FIG. 13 is a table that illustrates example values of pdf parameters for impedance extrema amplitudes of different cell types, according to an embodiment;

FIG. 14 is a block diagram that illustrates a computer system upon which an for embodiment of the invention may be implemented; and

FIG. 15 is a block diagram of an example mobile terminal (e.g., cell phone handset) for communications, which is capable of operating in the system of FIG. 3C, according to one embodiment.

### DETAILED DESCRIPTION

A method and apparatus are described for automatically determining cell shape or population cell type based on electrical impedance time series. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Some embodiments of the invention are described below in the context of certain cancer cell lines and transmission microscopy along with impedance statistics at one or more frequencies. In other embodiments other modalities of microscopy, such as phase contrast, and other impedance measurements at multiple different or similar frequencies are used to train machines for other types of human or animal or plant or fungal cells in vivo, or in vitro, with or without measurement of other physical attributes of the cells, such as shape, imagery, volume, mass, tagged fluorescence or radioactivity, or other property indicative of cell type.

### 1. OVERVIEW OF MACHINE LEARNING

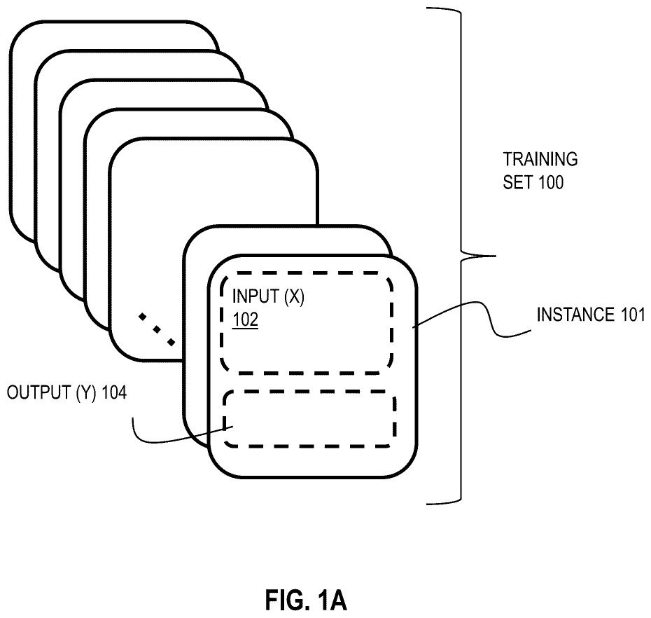

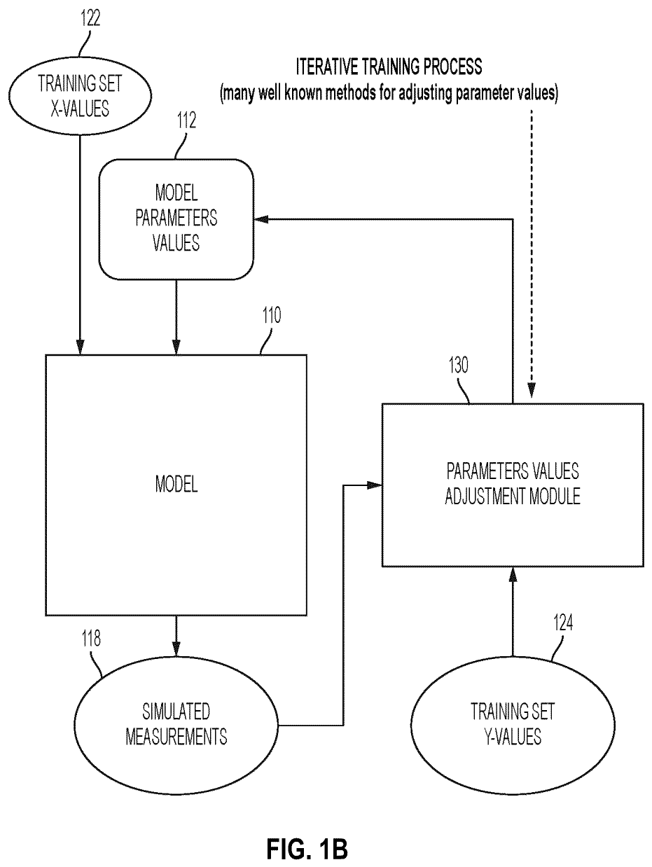

FIG. 1A is a block diagram that illustrates an example training set 100, according to an embodiment. The training set 100 includes multiple instances, such as instance 101. The instances 101 for the set 100 are selected to be appropriate for a particular use. Each training set 100 instance 101 include input data 102 (represented by the variable X, such as one or more input impedance time series or statistics thereof) and output data 104 (represented by variable Y, such as an image or cell type) desired to be output from the artificial intelligence machine (such as a classification or binary mask or vector of attributes or an output image) given the input data X 102.

In general, the artificial intelligence machine is programmed with a model M that includes a variety of adjustable parameters P, the values for which are determined by training with the training set 100 to provide a given output 104 for a given input 102 of each instance 101 of the training set 100. Many training methods are known and can be used alone or in combination to train the machine model based on the training set 100.

During machine learning, a model M is selected appropriate for the purpose and data at hand. One or more of the model M adjustable parameters P is uncertain for that particular purpose and the values for such one or more parameters are learned automatically. Innovation is often employed in determining which model to use and which of its parameters to fix and which to learn automatically. The learning process is typically iterative and begins with an initial value for each of the uncertain parameters P and adjusts those prior values based on some measure of goodness of fit of its Model output Y_{M} with known results Y for a given set of values for input context variables X from an instance 101 of the training set 100.

FIG. 1B is a block diagram that illustrates an example automatic process for learning values for uncertain parameters P 112 of a chosen model M 110. The model M 110 can be a Boolean model for a result Y of one or more binary values, each represented by a 0 or 1 (e.g., representing FALSE or TRUE respectively), a classification model for membership in two or more classes (either known classes or self-discovered classes using cluster analysis), other statistical models (such as mean and standard deviation of a Gaussian or Poisson function, shape and scale of a Gamma function, multivariate regression, or neural networks), or a physical model, or some combination of two or more such models. A physical model differs from the other purely data-driven models because a physical model depends on mathematical expressions for known or hypothesized relationships among physical phenomena. When used with machine learning, the physical model includes one or more parameterized constants, such as propagation loss coefficients, that are not known or not known precisely enough for the given purpose.

During training depicted in FIG. 1B, the model 110 is operated with current values 112 of the parameters P, including one or more uncertain parameters of P (initially set arbitrarily or based on order of magnitude estimates) and values of the input variables X 102 from an instance 101 of the training set 100. The values 116 of the output Y_{M} from the model M, also called simulated measurements, are then compared to the values 124 of the known or desired result variables Y 104 from the corresponding instance 101 of the training set 100 in the parameters values adjustment module 130.

The parameters values adjustment module 130 implements one or more known or novel procedures, or some combination, for adjusting the values 112 of the one or more uncertain parameters P of model M based on the difference between the values of Y_{M} and the values of Y 104. The difference between Y_{M} and Y 104 can be evaluated using any known or novel method for characterizing a difference, including least squared error, maximum entropy, fit to a particular probability density function (pdf) for the errors, e.g., using a priori or a posterior probability. The model M 110 is then run again with the updated values 112 of the uncertain parameters of P and the values of the input variables X 102 from a different instance 101 of the training set 100. The updated values 116 of the output Y_{M} from the model M110 are then compared to the values of the known result variables Y 102 from the corresponding instance 101 of the training set 100 in the next iteration of the parameter values adjustment module 130.

The process of FIG. 1B continues to iterate until some stop condition is satisfied. Many different stop conditions can be used. The model can be trained by cycling through all or a substantial portion of the training set. In some embodiments, a minority portion of the training set 200 is held back as a validation set. The validation set is not used during training, but rather is used after training to test how well the trained model works on instances that were not included in the training. The performance on the validation set instances, if truly randomly withheld from the instances used in training, is expected to provide an estimate of the performance of the learned model in producing Y_{M} when operating on target data X with results Y that are not already known. Typical stop conditions include one or more of a certain number of iterations, a certain number of cycles through the training portion of the training set, producing differences between Y_{M} and Y less than some target threshold, producing successive iterations with no substantial reduction in differences between Y_{M}, and errors in the validation set less than some target threshold, or no substantial differences in the parameter values P, among others.

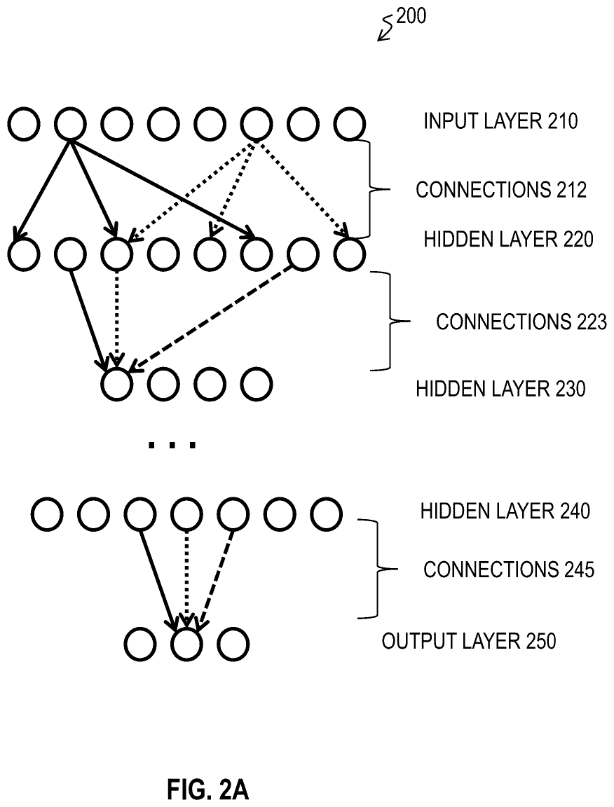

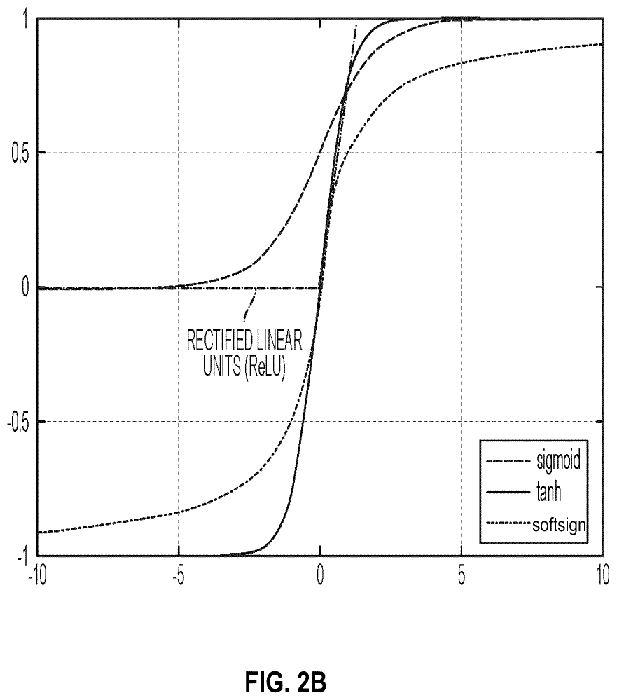

Effective training of an artificial intelligence system operating on images can be achieved using neural networks, widely used in image processing and natural language processing. FIG. 2A is a block diagram that illustrates an example neural network 200 for illustration. A neural network 200 is a computational system, implemented on a general-purpose computer, or field programmable gate array, or some application specific integrated circuit (ASIC), or some neural network development platform, or specific neural network hardware, or some combination. The neural network is made up of an input layer 210 of nodes, at least one hidden layer 220, 230 or 240 of nodes, and an output layer 250 of one or more nodes. Each node is an element, such as a register or memory location, that holds data that indicates a value. The value can be code, binary, integer, floating point or any other means of representing data. For feed forward networks, vValues in nodes in each successive layer after the input layer in the direction toward the output layer is based on the values of one or more nodes in a previous layer. The nodes in one layer that contribute to the next layer are said to be connected to the node in the later layer. Connections 212, 223, 245 are depicted in FIG. 2A as arrows. The values of the connected nodes are combined at the node in the later layer using some activation function with scale and bias (also called weights) that can be different for each connection. The weights are the adjustable parameters P of the neural network model. Neural networks are so named because they are modeled after the way neuron cells are connected in biological systems, including the human vision system and brain. A fully connected neural network has every node at each layer connected to every node at any previous or later layer. Training a neural network is called deep learning.

FIG. 2B is a plot that illustrates example activation functions used to combine inputs at any node of a neural network. These activation functions are normalized to have a magnitude of 1 and a bias of zero; but when associated with any connection can have a variable magnitude given by a scale and centered on a different value given by a bias. The values in the output layer 250 depend on the values in the input layer and the activation functions used at each node and the weights (scales and biases) associated with each connection that terminates on that node. The sigmoid activation function (dashed trace) has the properties that values much less than the center value does not contribute to the combination (a so called switch off effect) and large values do not contribute more than the maximum value to the combination (a so called saturation effect), both properties frequently observed in natural neurons. The tanh activation function (solid trace) has similar properties but allows both positive and negative contributions. The softsign activation function (short dash-dot trace) is similar to the tanh function but has much more gradual switch and saturation responses. The rectified linear units (ReLU) activation function (long dash-dot trace) simply ignores negative contributions from nodes on the previous layer, but increases linearly with positive contributions from the nodes on the previous layer; thus, ReLU activation exhibits switching but does not exhibit saturation. In some embodiments, the activation function operates on individual connections before a subsequent operation, such as summation or multiplication; in other embodiments, the activation function operates on the sum or product of the values in the connected nodes. In other embodiments, other activation functions are used, such as kernel convolution.

An advantage of neural networks is that they can be trained to produce a desired output from a given input without knowledge of how the desired output is computed. There are various algorithms known in the art to train the neural network on example inputs with known outputs. Typically, the activation function for each node or layer of nodes is predetermined, and the training determines the weights and biases for each connection. A trained network that provides useful results, e.g., with demonstrated good performance for known results, is then used in operation on new input data not used to train or validate the network.

In some neural networks, the activation functions, weights and biases, are shared for an entire layer. This provides the networks with shift and rotation invariant responses. The hidden layers can also consist of convolutional layers, pooling layers, fully connected layers and normalization layers. The convolutional layer has parameters made up of a set of learnable filters (or kernels), which have a small receptive field. In a pooling layer, the activation functions perform a form of non-linear down-sampling, e.g., producing one node with a single value to represent four nodes in a previous layer. There are several non-linear functions to implement pooling among which max pooling is the most common. A normalization layer simply rescales the values in a layer to lie between a predetermined minimum value and maximum value, e.g., 0 and 1, respectively.

Attention is an artificial intelligence process that gives more weight to one object detected than another, e.g., giving more weight to specific pixels near edges in the input sequence than other pixels.

It has been found that convolutional neural networks of limited depth provide advantages in characterizing objects in imagery.

### 2. MACHINE LEARNING FOR VIRTUAL CELL IMAGE

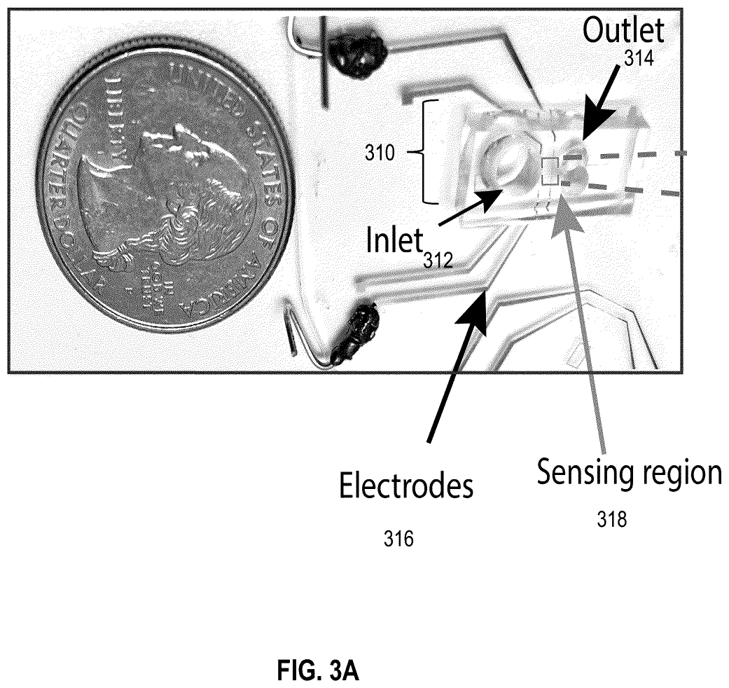

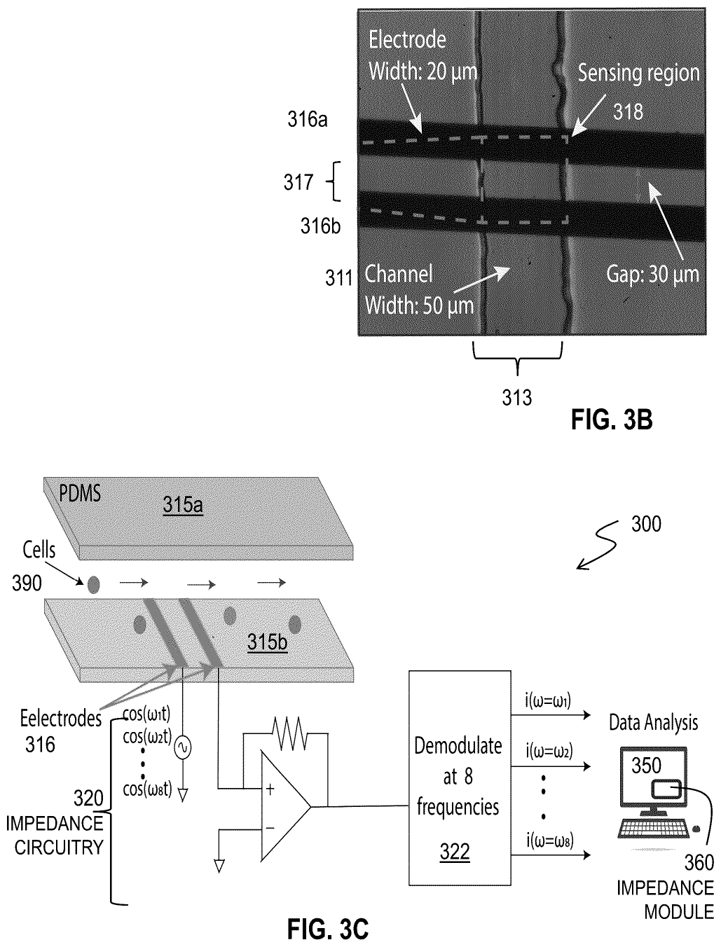

FIG. 3A through FIG. 3C are photographs and a block diagram, respectively, that illustrates an example of a system for making and using impedance measurements of biological cells at multiple frequencies, according to various embodiments. The photograph of FIG. 3A depicts a microfluidic device 310 that includes an inlet opening 312 and an outlet opening 314 connected by a microfluidic channel (not shown in FIG. 3A) that directs fluid through a sensing region 318. The device 310 also includes electrodes connected to external electrodes 316. The device is miniature as indicated by the size comparison to the US quarter Dollar coin included in the photograph. FIG. 3B is a micrograph that depicts the microchannel 311 connecting inlet 312 to outlet 314. The microchannel 311 has a width 313 of 50 microns (μm, 1 μm=10⁻⁶ meters) sufficient to allow individual cells to pass as they flow with a surrounding fluid. A pair of electrodes, 316a and 316b, each 20 microns wide, has a gap 317 between them of the same order of magnitude. The sensing region 318 between dashed line<is the overlap between the pair of electrodes, the gap 317, and the channel 311. The sensing region 318 is large enough to entirely enclose a cell for which an impedance measurement is desired.

FIG. 3C is a block diagram of a system 300 that gives a perspective view of the channel 311 carrying cells 390 between top and bottom panels 315a and 315b, respectively, made of Polydimethylsiloxane, called PDMS or dimethicone, a polymer widely used for the fabrication and prototyping of microfluidic chips, such as microfluidic device 310. FIG. 3C shows that the electrodes 316 are connected to impedance circuitry 320 that drives a voltage at one electrode electrodes at one or more frequencies (represented by the variable ω₁ through ω₈) and measures the voltage induced in the second electrode. Electrical impedance indicates an amount of opposition to inducing a voltage change in the second electrode. It is often dependent on the time rate of change of the voltage, such as the frequency of an alternating current (AC). So, the measured voltage or current at the second electrode is inversely related to the impedance. The demodulator 322 separates the current or voltage signals at the different driving frequencies and feeds the demodulated impedance data to computer system 350, where an impedance module 360 (some combination of hardware and software) processes, stores or uses the impedance data, or some combination. The system 300 includes the microfluidic device 310, the impedance circuitry 320, including demodulator 322, and the impedance module 360 operating on computer 350. Though cells 390 are depicted in FIG. 3C, the cells 390 and the fluid pushing the cells 390 through the channel are not part of the system 300.

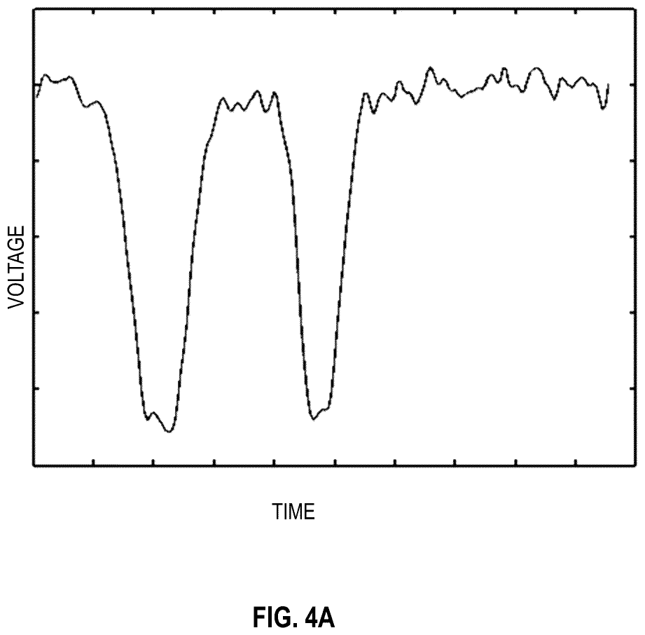

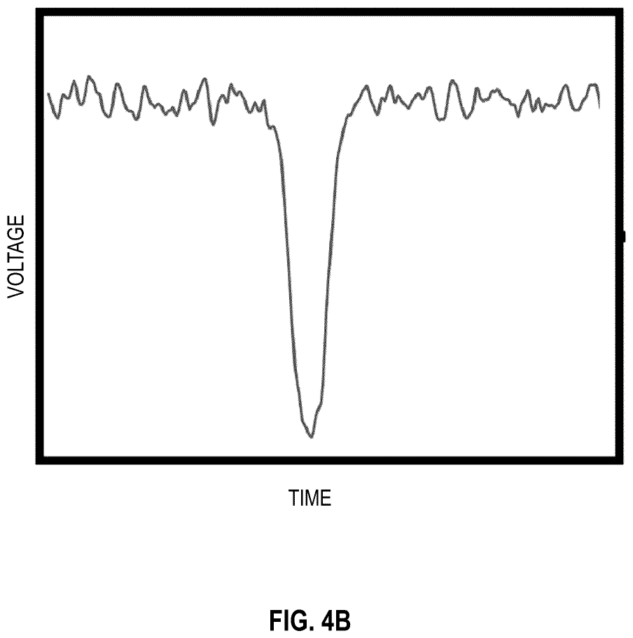

FIG. 4A and FIG. 4B are plots that illustrate examples of impedance measurements at a single frequency, according to an embodiment. On each, the horizontal axis indicates time in relative units, and the vertical axis indicates voltage in relative units. The two valleys in the trace plotted in FIG. 4A indicate the passage of two cells one after the other through the sensing region 318. These voltage valleys correspond to peaks in impedance. To avoid confusion in referring to the voltage valleys and corresponding impedance peaks, these features are called extrema, singular extremum. The amplitude of an extremum is the difference between the background average adjacent to but outside the extremum and the point in the extremum furthest from the average background. Temporal sampling is sufficient to place several measurement points inside each extremum. The number of samples in an extremum can be controlled by the temporal sampling rate and the flow rate of cells 390 in the microchannel 311. FIG. 4B plots a trace of voltage that indicates the passage of one cell resulting in only one extremum. Qualitatively similar but quantitatively different traces are associated with other driving frequencies as this same cell occupies the sensing area.

In order to use such impedance time series measurement as depicted in FIG. 4B to produce a virtual image of the cell producing the impedance trace, a training set with both impedance data and cell imagery is assembled.

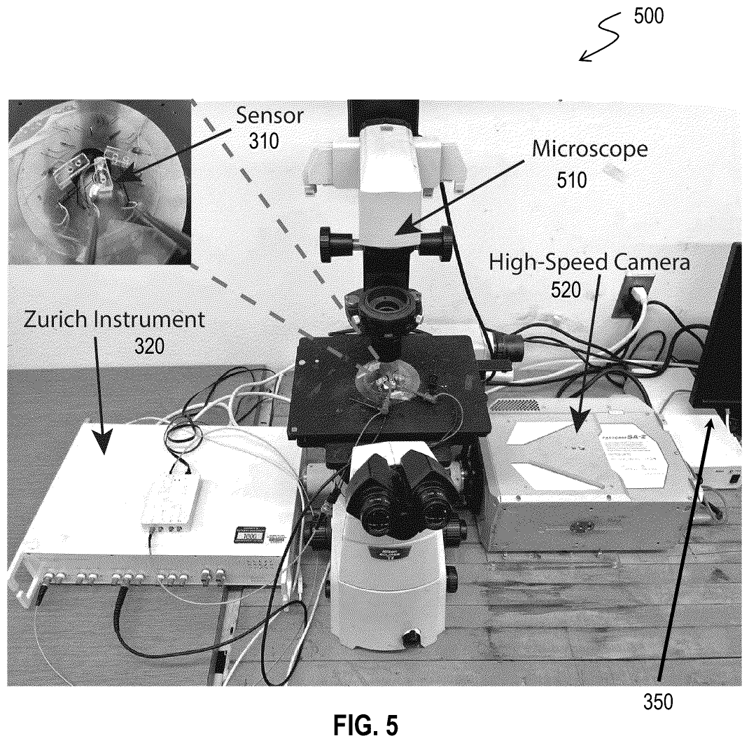

FIG. 5 is a photograph of an example of a system 500 for making simultaneous impedance and video measurements of biological cells for training an example neural network, according to an embodiment. This system 500 includes a microscope 510 and high-speed camera-video recorder 520 in addition to the components of system 300, microfluidic device 310 as the impedance sensor, Zurich instrument as the impedance driving and recording circuitry 320, and computer system 350 where the impedance module 360 operates. Although processes, equipment, and data structures are depicted in FIG. 5 as integral blocks in a particular arrangement for purposes of illustration, in other embodiments one or more processes or data structures, or portions thereof, are arranged in a different manner, on the same or different hosts, in one or more databases, or are omitted, or one or more different processes or data structures are included on the same or different hosts.

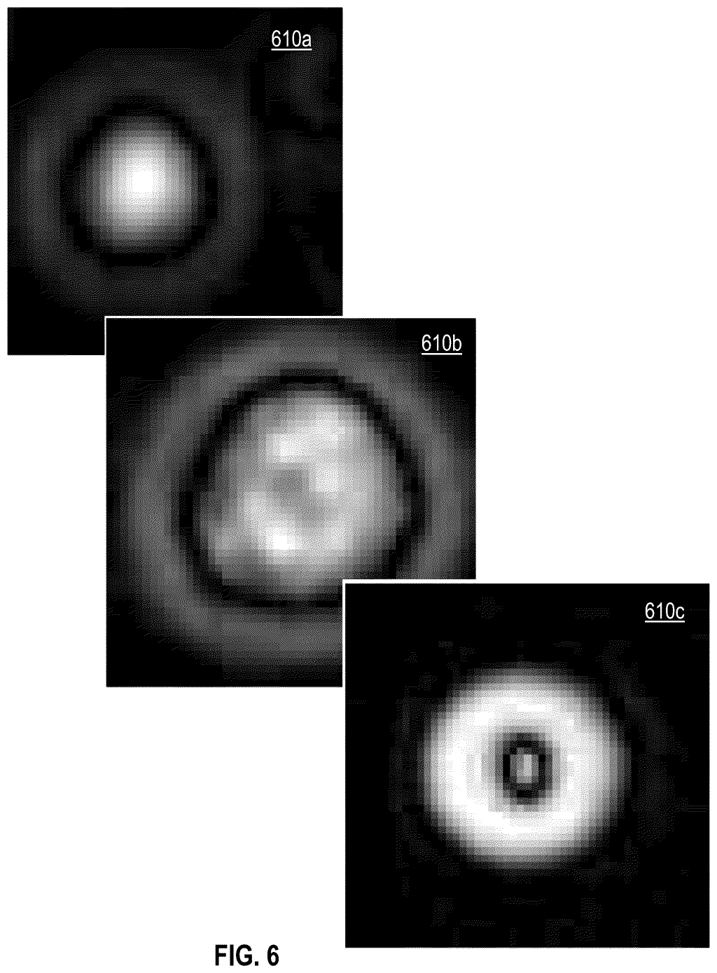

FIG. 6 is a set of examples of images captured by the system of FIG. 5 for training the neural network, according to an embodiment. A wide variety of cell images are collected, as represented by the images 610a, 610b, and 610c depicted in FIG. 6, each making up desired output Y with a corresponding impedance time series, as shown in FIG. 4A, making up the input X.

Any device capable of taking microscopic images successively in time may be used, including optical transmission or confocal microscopes 510 with a camera or charge-coupled device CCD or similar image capture device 520 viewing a slide, a petri dish, a fluid channel or microfluidic channel, or a scanning electron microscope similarly situated. The output of microscopic video device 510 includes multiple time separated images (also called image frames or simply frames) of the sample viewing area. Collected together in time order, the image frames are called microscopic video data (or simply microscopic video). Microscopic video frames collected for training in deep machine learning makes up the output values Y of the training set.

Once the training set is assembled, a neural network can be trained. Any neural network capable of producing a useful result can be used, including a neural network with multiple fully connected hidden layers of a variable number of nodes. Experiments have shown useful results are obtained using an input layer of impedance time series points that encompass the passage of a single cell, with anywhere from 50 to 5000 temporal points found to be useful. In some embodiments, the number of time series points sampled for the passage of a single cell is in a range from 100 points to 200 points per frequency, for up to 1600 points for 8 impedance frequencies. In a specific embodiment described in more detail in below, the sampling time and flow rate is such that 191 points at a single measurement frequency captures the useful structure in a cell that is reflected in the cell image. The output of the neural network is a layer with enough nodes that a cell image can be formed. Such an image is found to be useful with anywhere from 50 by 50 pixels (2500 output nodes) to 200 by 200 pixels (40,000 output nodes). In the example embodiment, the output image layer represents an image of 150 by 150 pixels, in an output layer of 22,500 nodes. To avoid noisy detail in the example embodiment, at least some of the inner layers have fewer nodes than either the input layer or the output layer.

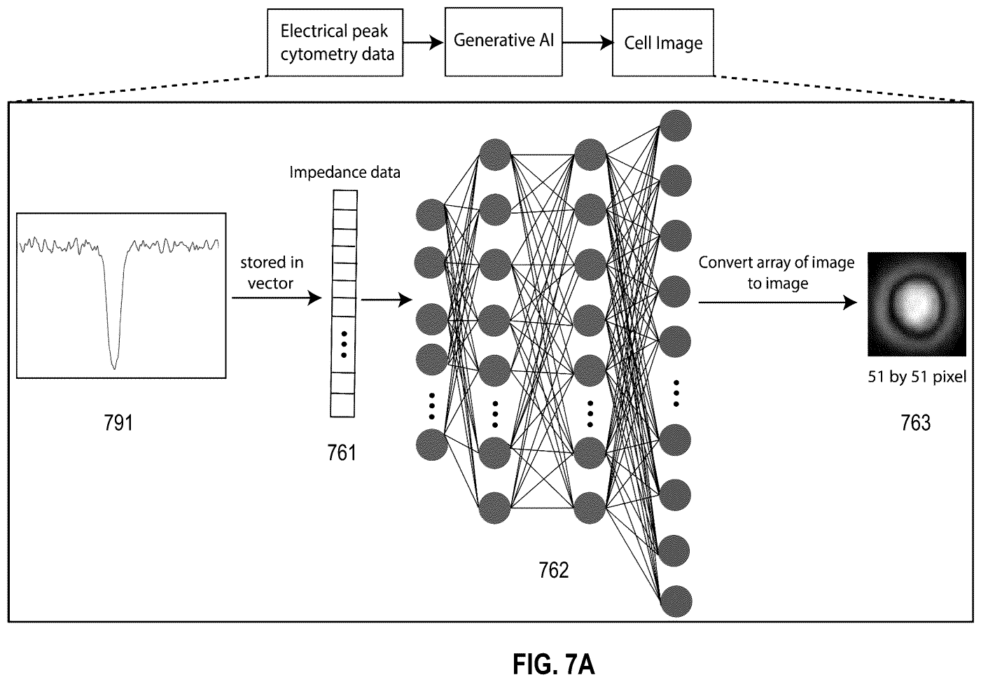

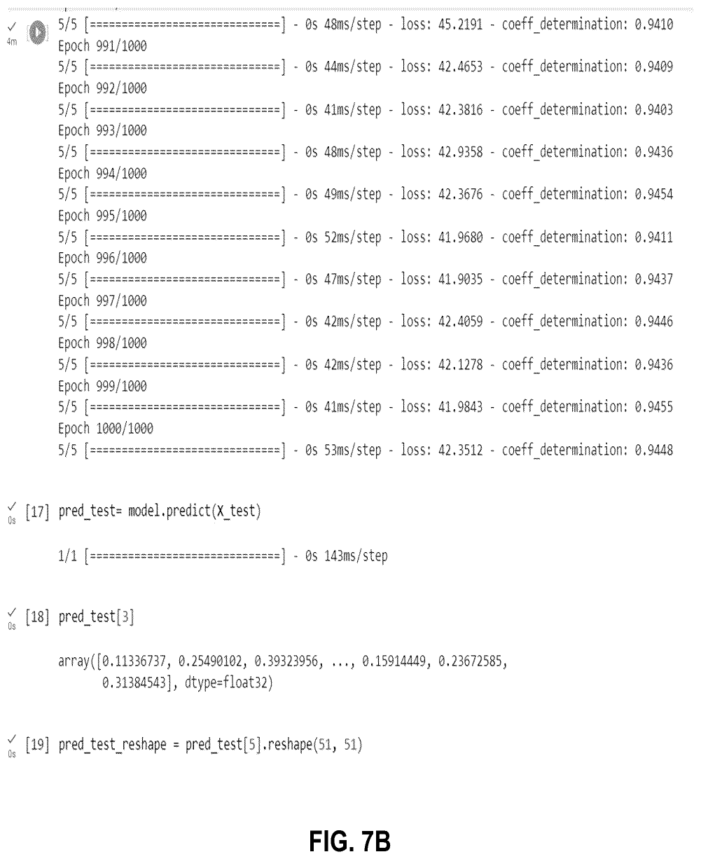

After training, the neural network is used as part of impedance module 360 to produce a virtual image based on the time series of impedance measured during the passage of a single cell through the sensing region at one or more AC frequencies. FIG. 7A is a block diagram that illustrates use of the neural network after training, according to an embodiment. The input impedance time series of a single extremum 791, such as a measured electrical peak from cytometry data, is converted to a vector 761 of input nodes, with or without some preprocessing, such as normalization. The values in the input nodes cause the previously trained neural network 762 to act as generative Artificial Intelligence (AI) to output values at the output nodes which are then used as intensity of one or more colors in a two dimensional array of pixels to produce the output image 763 of a cell that corresponds to the input impedance data.

FIG. 7B is a listing of image similarity during validation testing of the neural network indicating good performance, according to an embodiment. It shows good performance when used on a validation set, in which the output image is known, but which was not used during training of the neural network. Any measure of image similarity may be used. In the example embodiment, described as described below, a Multi-Scale Structural Similarity Index (MSSIM) is used. MSSIM is an extension of the Structural Similarity Index (SSIM) that incorporates information from multiple scales of the image. MSSIM takes into account not only the similarity at the pixel level but also at various levels of abstraction or lower resolution within the image. This makes MSSIM particularly useful for assessing the perceptual quality of images, especially when there are variations in scale or when comparing images with different resolutions. When comparing an original image and a predicted image using MSSI, the images are first decomposed into multiple scales or levels using a Gaussian pyramid or similar technique. SSIM is then computed at each scale, considering the luminance, contrast, and structure at that scale. The SSIM values from different scales are then combined using a weighted average, typically giving more importance to finer details and less importance to coarser scales. MSSIM provides a more comprehensive assessment of image similarity compared to SSIM alone because it considers information across different scales. This makes it more robust to variations in resolution, noise, and other factors that can affect image quality. In summary, MSSIM is a measure of similarity between images that takes into account information at multiple scales, providing a more nuanced evaluation of image quality and similarity compared to traditional SSIM. Using MSSIM as the measure of similarity, called a coefficient of determination in FIG. 7B, the validation images were reproduced with over 94% similarity based on impedance time series of a single cell alone input to the trained neural network.

The high degree of similarity for the virtual imagery demonstrates a marked improvement in the assessment of health, diagnosis of disease, and tracking of disease treatment efficacy by enabling the replacement of expensive, bulky and manually operated microscopes and ancillary equipment, such as microscope 510 depicted in FIG. 5, with a small, portable and disposable microfluidic device, such as microfluidic device 310 depicted in FIG. 3A, and microelectronics for impedance measurement with a mobile processor, such as a smart phone, with or without a network connection to a remote server, wherein the local or remote processor implements the neural network and produces the virtual image.

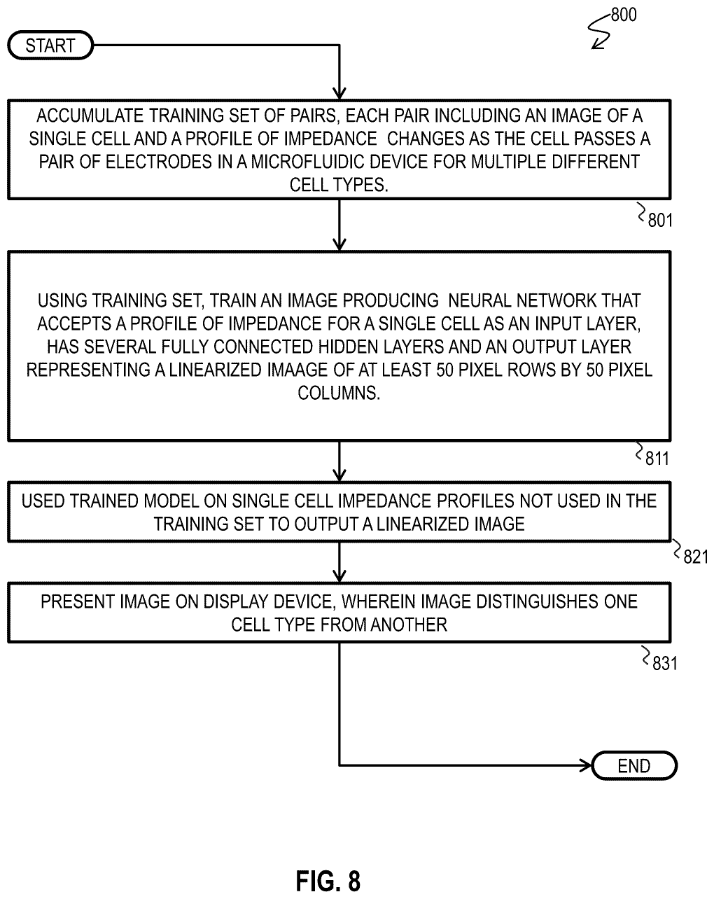

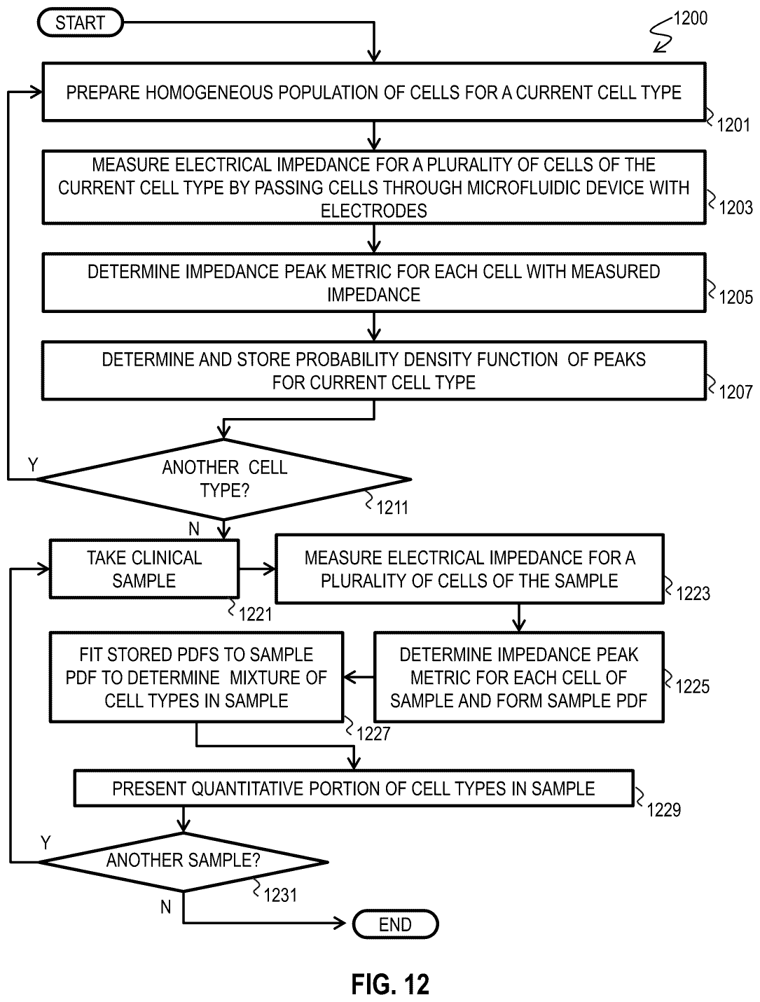

FIG. 8 is a flow chart that illustrates an example method to train and use a neural network for single cell imaging based on impedance, according to an embodiment. Although steps are depicted in FIG. 8, and in subsequent flowchart FIG. 12, as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In step 801, a training set is accumulated using published data or data collected by the system of FIG. 5. Each training set instance includes an impedance time series as a cell traverses the pair of electrodes (called herein an impedance profile) as depicted for example in FIG. 4B, and a corresponding cell image such as shown by one of the images depicted in FIG. 6. In some embodiments, the microscopic image of the training instance single biological cell is a single frame of a microscopic video viewing a gap between a pair of electrodes in a microfluidic channel as the training instance single biological cell traverses the gap to obtain the single cell impedance observation data for the training instance single biological cell. Preferably the training set includes multiple instances for each of multiple different cell types, such as normal and cancerous breast cancer cells. The training may be done in one microfluidic device and used with measurements in a different microfluidic device with the same configuration in the sensing region.

In step 811, using training set assembled in step 801, an image producing neural network is trained. The neural network that accepts a vector based on a profile of impedance for a single cell as an input layer, has several hidden layers and an output layer of nodes representing a linearized image of at least multiple pixel rows by multiple pixel columns. In some embodiments the output layer includes a number of nodes in a range from 2000 to 40,000 nodes. In various embodiments, the input layer includes a number of nodes in a range from 50 to 2000 nodes. Step 811 includes any preprocessing on the impedance profile data to make it suitable as input to the model including any normalization, smoothing or other data conditioning. Step 811 also includes any image conditioning, such as normalization or smoothing or other image processing of the training set image and any transformation between the output layer and the two dimensional image, wherein each image distinguishes one cell type from another.

In some embodiments, one or more of the hidden layers has a number of nodes less than the number of nodes in either the input layer or the output layer or both. An advantage of a smaller number of nodes in a hidden layer is to avoid overtraining for image features of too small a scale that can be perceived as noise. In some embodiments each layer is fully connected to preceding and following layers. In some embodiments, pooling, convolutional, and recurrent layers are used. Neural network designs vary widely to accommodate the unique requirements of different applications, featuring a range of architectures such as convolutional layers for spatial data, recurrent layers for sequential data, and transformers for complex sequence understanding. Each type offers specific advantages, with convolutional networks using smaller kernels for efficient pattern recognition in images, while recurrent and transformer layers capture temporal and contextual relationships in sequences, respectively. This diversity allows for tailored solutions that optimally address the problem at hand, leveraging the strengths of each architecture to enhance model performance. In the realm of activation functions, choices like ReLU, sigmoid, tanh, and softmax introduce necessary non-linearity (e.g., switching and saturation effects), enabling networks to learn complex patterns.

Thus step 811 illustrates training a neural network on a plurality of training instances, each training instance comprising single cell impedance observation data for a training instance single biological cell and a microscopic image of the training instance single biological cell. In some embodiments, step 811 includes using validation data to characterize the similarity of the neural network output to validation images.

In step 821, the trained image producing neural network is used on one or more single cell impedance profiles not used in the training set as input to output a linearized image for each impedance profile. Step 821 includes any preprocessing on the impedance profile data to make it suitable as input to the model including any normalization, smoothing or other data conditioning. Thus step 821 illustrates measuring single cell impedance observation data that indicates a time series of impedance measurements during an observation time in which a single biological cell traverses a first gap between a first pair of electrodes in a first microfluidic channel. Step 821 includes any post processing on the output nodes to transform the output to an image of a cell type. Thus step 821 also illustrates generating a virtual image of the single cell using a neural network.

In step 831, the cell type image is presented on a display device, wherein the cell type image distinguishes one cell type from another. Thus step 831 illustrates presenting the virtual image of the single cell on a display device.

Example embodiments of the method 800 for particular breast cancer cell types are described in more detail in the examples section.

### 3. MACHINE LEARNING FOR CELL POPULATION TYPES

In some embodiments, the types of cells in a population are of interest rather than the cell type of an individual cell. For such cell population typing, virtual images of individual cells are not efficacious. Here is described a method for distinguishing population cell types based on multiple cell impedance measurements that can be performed quickly with microfluidic device 310. As a cell travels through the channel's sensing region, an electric field is applied. This interaction disrupts the alternating current (AC) signal at each of several AC frequencies, resulting in a detectable referred to as a “peak” or “extremum.” This method has been employed with various types of cancer cells, including both adherent and suspension categories as they represent solid tumors and hematological malignancies, respectively. Impedance data is gathered as hundreds of cells pass successively through device 310, analyzing the collective impedance characteristics of the cell population. Importantly, this setup is versatile, allowing for the application of up to eight different AC frequencies, ranging from 100 kHz to 2 MHz, to accommodate diverse experimental needs.

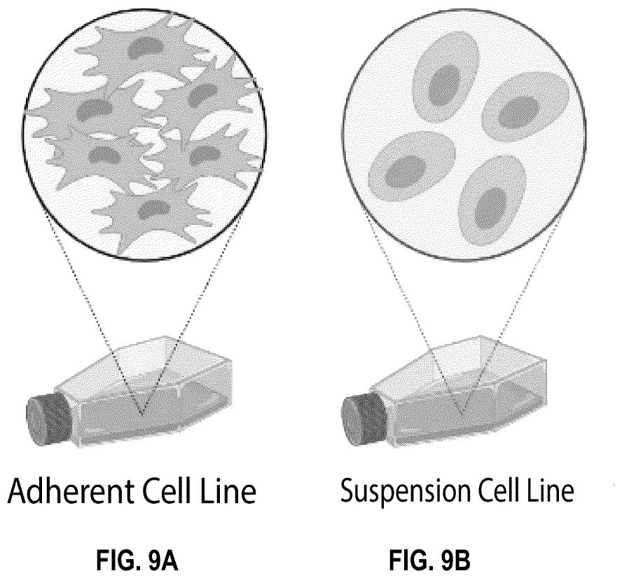

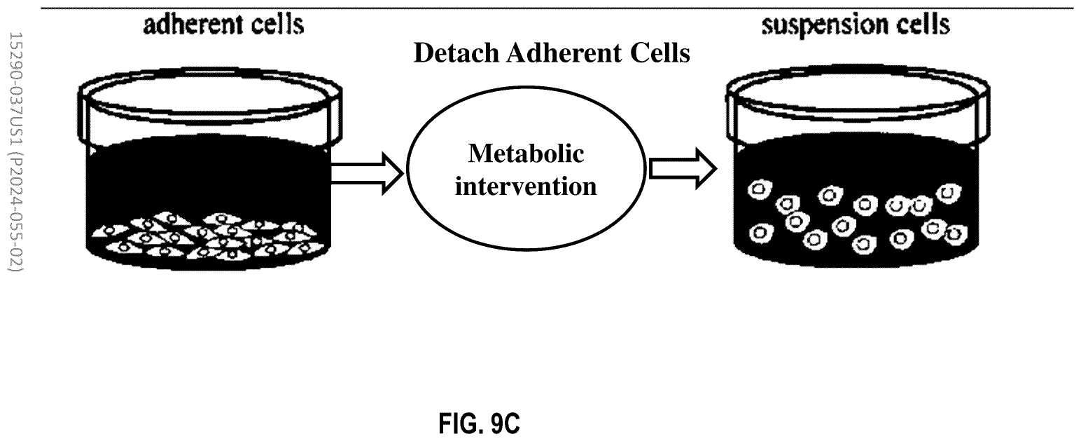

There are various ways to make multiple cell impedance measurements of various cell types. Cancer cells are studied based on a variety of standard cell lines so that research and clinical results can be compared across laboratories. Some cell lines are propagated as adherent cells in culture, while others are propagated as a liquid suspension. FIG. 9A through FIG. 9C are block diagrams that illustrate examples of populations of different cell types to distinguish using impedance measurements, according to an embodiment. FIG. 9A depicts an example of an adherent cell line in culture. FIG. 9B depicts an example of a suspension cell line in suspension. FIG. 9C depicts a process for bringing adherent cells into suspension, by some metabolic intervention. Such metabolic intervention, for example using a cancer treatment medicament, changes structural and impedance profiles of the cell as they are transformed from adherent state to a suspended state before the transformed cells die by different mechanisms.

Both adherent cells and suspension cells can be pushed through a microfluidic impedance device such as device 310. The suspension cell types can be used directly either within their suspension fluid or after washing with saline (phosphate buffer saline). The adherent cells are first mechanically separated from the culture such as by using a cell scraper or chemically separated from the culture using trypsin or other mild cell detachment buffer (rather than being detached by a metabolic process from the culture) and then are captured in a growth media and finally washed with saline before passing through the microfluidic device 310. Also, both adherent and suspension cells were suspended finally in saline (phosphate buffer saline) in order to have the same electrical background.

Thus although both types of cells, from adherent and suspension cells, end up in suspension, hereinafter the term suspension refers to cells that originate in a suspension or originated as adherent cells in culture or a solid tumor that were suspended by a metabolic process. Hereinafter, the term adherent is used to refer to cells that originated in culture or a solid tumor and were mechanically and/or chemically suspended but not metabolically suspended.

After passage of multiple cells from the population through a cell impedance device, like device 310, a trace with multiple extrema is produced, one extremum per cell. Properties of the extrema vary from one cell to the next, even for cells of one cell type. Such variability in the properties or characteristics can be captured by the statistics of that variability, such as mean value and variance, other moments such as skewness or kurtosis, or a full probability density function (PDF) trace for each of one or more properties, e.g., width of extremum at the base or at half the distance to the extremum or other depth, depth of extremum as an absolute impedance (amplitude) or a percentage change from the background, or total area of valley below the background. It has been discovered that different cell types can sometimes be distinguished based on detectable differences in the statistics or PDFs associated with the populations of the cell types.

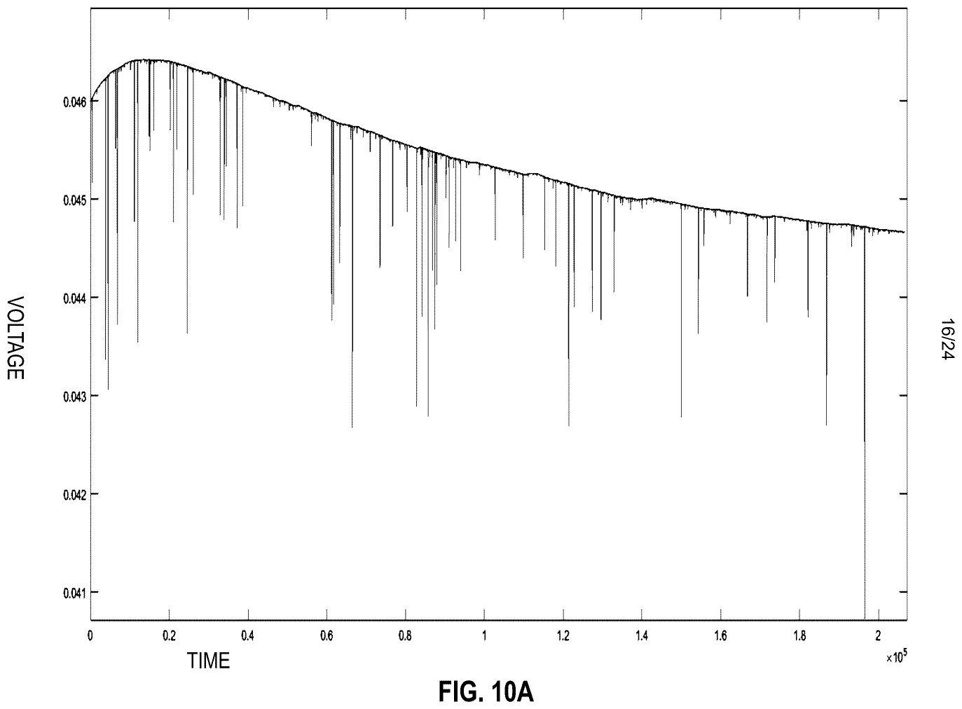

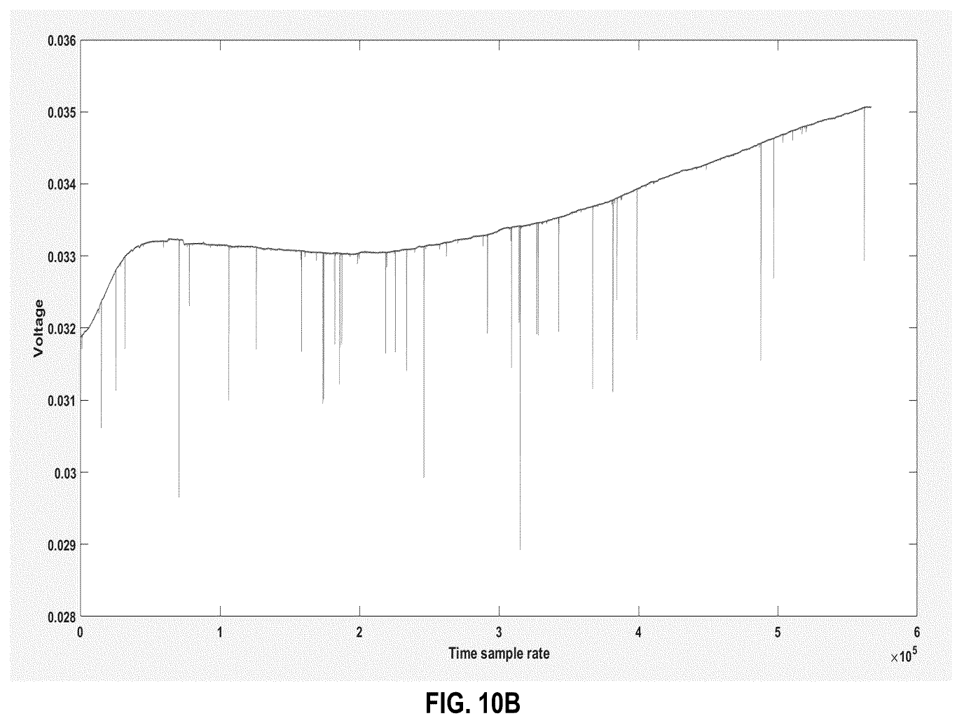

FIG. 10A and FIG. 10B are plots that illustrate examples of population impedance observations, for which amplitudes of extreme deviations (extrema) from background are characterized by probability density functions, according to an embodiment. The horizontal axis indicates time in units of thousands of samples at a particular sampling rate, and the vertical axis indicates voltage (inversely proportional to impedance). Each plot shows a slowly varying background voltage peppered by sharp valleys of varying width and depth (amplitude).

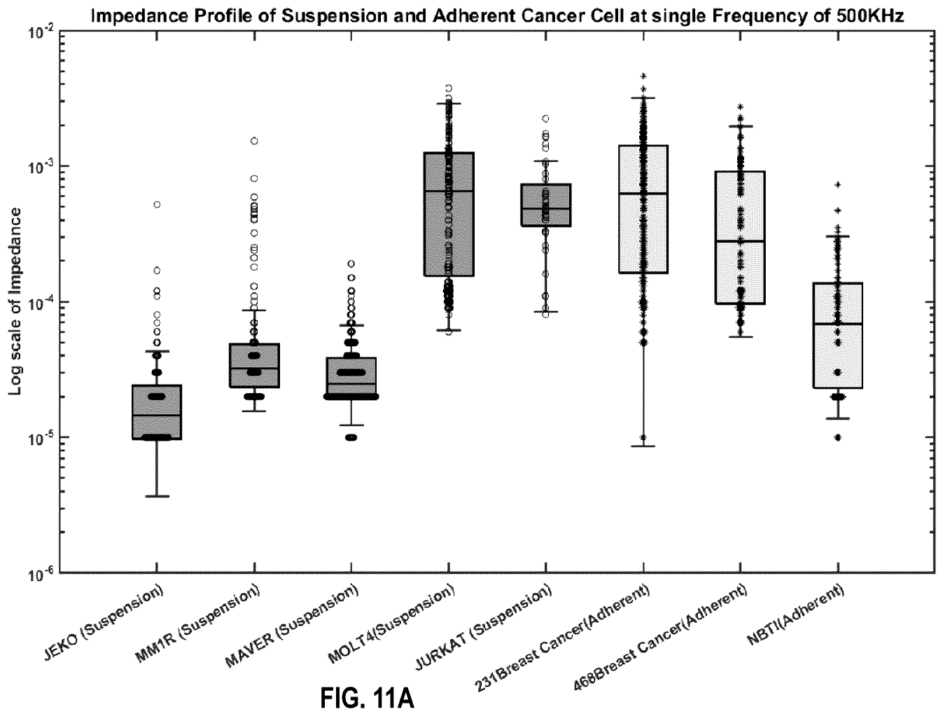

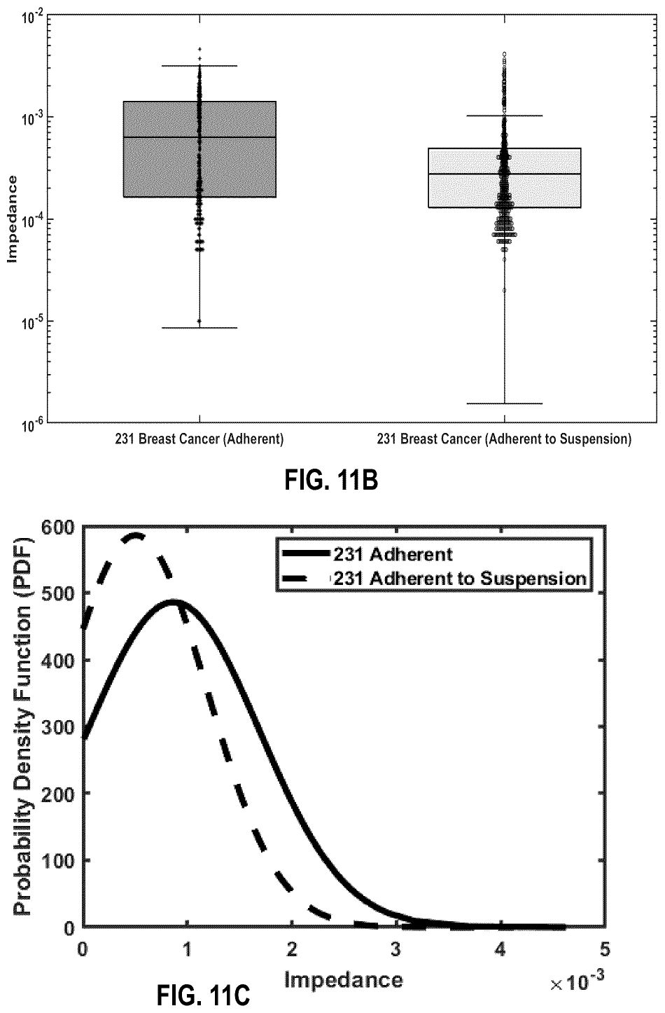

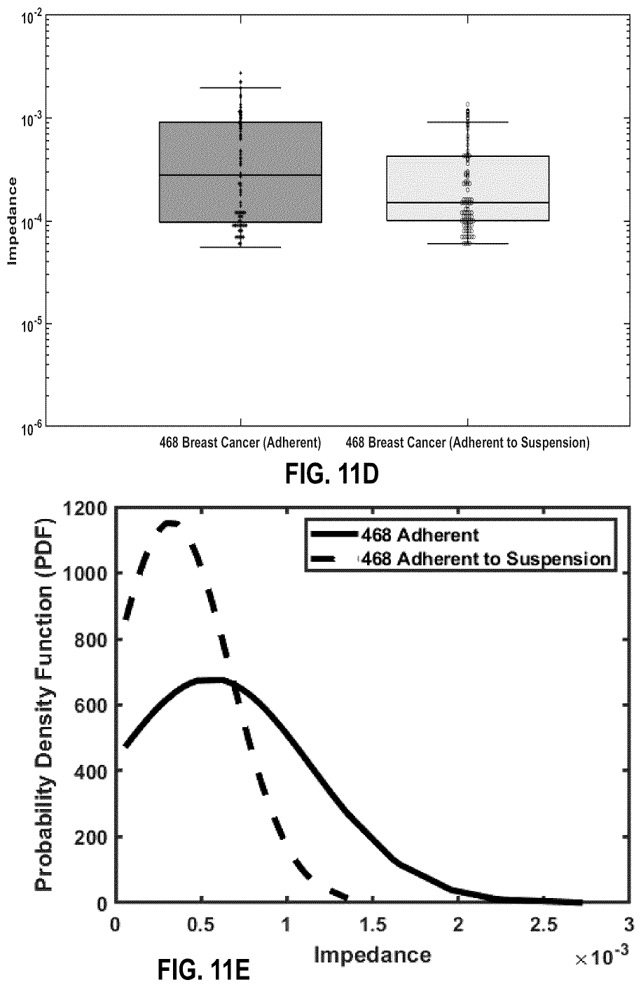

FIG. 11A is a plot that illustrates examples of the distributions of extrema amplitudes for different cell types, according to an embodiment. The horizontal axis indicates each of 8 cell types; and the vertical axis indicates the log of the impedance, where the impedance is expressed in ohms. Methods for handling populations of these cell types are described in more detail in the examples section.

The 8 cell types are JeKo-1 (labeled JEKO) suspension cell line, MM-1R (labeled MM1R) suspension cell line, Maver-1 (labeled MAVER) suspension cell line, MOLT-4 (labeled MOLT4) suspension cell line, JURKAT suspension cell line, MDA-MB-231 Breast Cancer (labeled 231Breast Cancer) adherent cell line, MDA-MB-468 Breast Cancer (labeled 468Breast Cancer) adherent cell line, and NBT-I (labeled NBTI) adherent cell line. JEKO (JeKo-1) is a lymphoblast cell line isolated from the peripheral blood of a female showing leukemic conversion. MM1R (MM. 1R) is a B lymphoblast cell line that was isolated in 1990 from the peripheral blood of a 42-year-old, Black female with multiple myeloma who had become resistant to steroid-based therapy. MAVER (MAVER-1) is a lymphoblast cell line isolated in 2003 from the peripheral blood of a 77-year-old male with mantle cell lymphoma. MOLT4 (MOLT-4) is a T lymphoblast cell line derived from the same patient as the MOLT-3 cell line (ATCC CRL-1552) established from cells taken from a 19-year-old, male patient with Acute lymphoblastic leukemia (ALL) in relapse. JURKAT (Jurkat) cells are an immortalized line of human T lymphocyte cells that are used to study acute T cell leukemia, T cell signaling, and the expression of various chemokine receptors susceptible to viral entry, particularly HIV. 231Breast Cancer (MDA-MB-231) cell line is a “triple-negative” breast cancer, the cells of which do not express the estrogen receptor, progesterone receptor, or HER2 protein. 468Breast cancer (MDA-MB-468) is a cell line with epithelial morphology that was isolated from a pleural effusion of a 51-year-old Black female patient with metastatic adenocarcinoma of the breast. The NBT1 cell line is a murine derived breast cancer cell line. The NBT1 mammary tumor cell line was derived by serial cell culture of tumor cells expressing HER2/neu which were obtained from a spontaneous breast tumor that arose in a FVB/neuT mouse transgenic for a HER2/neu receptor that is constitutively activated by a point mutation in the transmembrane region.

For each of the 8 cell types, the observed impedance spike amplitudes are plotted as circles in a single column in FIG. 11A. The mean of the distribution is indicated by a horizontal line, and the standard deviation by a shaded box centered on the mean. Note that the box is stretched below the mean compared to the height above the mean because of the log scale of the vertical axis. There is clear overlap in impedance spike amplitude values, which makes a single amplitude value ambiguous as to cell type. However, there is also a clear difference in the distributions as indicated by the plotted means and or variance and or tail values among several cell types.

FIG. 11B is a plot that illustrates examples of differences in distribution of adherent and suspended cell lines for a first type of breast cancer, according to an embodiment. The horizontal axis indicates each of 2 cell types; and the vertical axis indicates the log of the impedance. The two cell types are the 231 Breast Cancer adherent cells as plotted in FIG. 11A and the same cell line after metabolic intervention and suspension. Adherent breast cancer cells (MDA-MB-231 and MDA-MB-468) were grown in their respective growth medias (in petri-dish or flasks) and when these cells reach over-confluence (i.e., no attachment space available to grow) and growth media is over-spent (i.e., depleted of major growth factors, shown by color change from pink to yellow), this is called metabolic intervention, and thus these cells are transformed to suspension cells. The cells start losing the attachment with the surface of petri dish or flasks (used for growing these cells) and becomes suspension cells as they start floating in that over-spent growth media. These metabolically suspended cells were captured like the usual suspension cells. Their viability was checked and compared with the remaining adherent cells obtained from same culture. For instance, 11B and 11C shows the MDA-MB-231 cells (adherent that are chemically or mechanically treated to pass through the microfluidic device) and MDA-MB-231 adherent to suspension cells (which were adherent originally but metabolically transformed to suspension due to overgrown in the same petri-dish) were captured as viable cells, before they ultimately die due to lack of growth media for progression. The means and variances are clearly different. FIG. 11C is a plot that illustrates examples of probability density functions of the distributions depicted in FIG. 11B, according to an embodiment. The horizontal axis indicates impedance in thousandths of ohms and the vertical axis indicates relative amount such that the area under the PDF curve is equal to 1. The adherent 231 Breast cancer cells have a PDF indicated by the solid line, while the suspension 231 Breast cancer cells affected by metabolic intervention have a clearly different PDF indicated by the dashed line.

FIG. 11D and FIG. 11E correspond to FIG. 11B and FIG. 11C, respectively, but for a second type of breast cancer, according to an embodiment. In FIG. 11D, the horizontal axis indicates each of 2 cell types; and the vertical axis indicates the log of the impedance. The two cell types are the 468 Breast Cancer adherent cells (chemically or mechanically separated) as plotted in FIG. 11A and the same cell line after metabolic intervention and suspension. The means and variances are clearly different. FIG. 11E is a plot that illustrates examples of probability density functions of the distributions depicted in FIG. 11D, according to an embodiment. The horizontal axis indicates impedance in thousandths of ohms and the vertical axis indicates relative amount such that the area under the PDF curve is equal to 1. The adherent 468 Breast cancer cells have a PDF indicated by the solid line, while the suspension 468 Breast cancer cells affected by metabolic intervention have a clearly different PDF indicated by the dashed line.

These population statistics are for homogeneous populations. These cells were derived from a same clone originally when established as a stable cell line and before using them for impedance measurement, their morphology and confluency were checked using a bright field microscope to ensure they look similar in morphology and look healthy without any stress. In order to homogenize the samples after collecting them from the growth culture, they were mixed with the growth media or final solution of PBS (phosphate buffer saline) using pipette-man and checked the viability as well as their size distribution using the Vi-CELL Series Cell Viability Analyzer (Beckman Coulter, Carlsbad, CA) (which shows that there are single cell population maximally in the solution and not as cluster of cells).

Given the learned PDFs of homogeneous population of separate cell types, such as plotted in FIG. 11C and FIG. 11E, the PDF of a mixture can be probabilistically ascribed to a particular combination of the PDFs of the homogeneous cell types. For example, an observed PDF from a sample can be broken down as a linear combination of a first percentage of a first homogeneous cell type and a second percentage of a second homogeneous cell type etc. to determine at least the probable major components contributing to the sample mixture. A priori probabilities based on prior knowledge can also be used in estimating the contribution from one or more cell types, such as the fact that the sample came from a breast tissue biopsy rather than a blood sample. This estimation of portions of homogeneous cell types in a sample can be performed using any method known in the art.

FIG. 12 is a flow chart that illustrates an example method 1200 to train and use probability density functions for different cell types in analyzing population impedance extrema from a sample, according to an embodiment. In step 1201, a homogeneous population of cells for a current cell type is prepared. In step 1203, electrical impedance is measured for a plurality of cells of the current cell type by passing multiple cells through a microfluidic device with electrodes, such as device 310. In order to get a statistically significant sample, it is preferable that at least 100 cells of the homogeneous cell type population have their impedance extrema measured. In some embodiments, at least 500 or at least 1000 cells of the homogeneous cell type population have their impedance extrema measured. Thus step 1203 illustrates measuring population impedance observation data that indicates a time series of impedance measurements during a population observation time in which a plurality of biological cells of a homogeneous cell type population traverses a first gap between a first pair of electrodes in a first microfluidic channel.

In step 1205, at least one metric of the impedance extrema, such as peak amplitude or peak width or peak area is determined for each extremum from the impedance data for the homogeneous population of the cell type. In step 1207, a PDF for the at least one metric for the homogeneous population of the cell type is determined and stored in memory. Thus, the PDF for the cell type is machine learned by learning values for the parameters P that define the PDF, such as mean, variance or other moments of the distribution or scale and shape parameters of a gamma function that approximates the observed PDF, or some combination. Step 1207 illustrates forming a database storing a probability density function of values of the metric of isolated extrema in impedance training data for each cell type of a plurality of cell types.

In step 1211, it is determined whether there is another cell type for which to learn a PDF. If so, control passes back to step 1201 and following steps to prepare a population of cells for the next cell type and learn the PDF for the metric for that cell type. If there is no other cell type to learn, then control passes to step 1221.

In step 1221, a clinical sample is collected from a subject, such as a microorganism, a plant, an animal, or a human. In step 1223, the electrical impedance is measured for multiple cells of the sample, preferably from at least 500 cells, and more preferably from at least 1000 cells. Thus step 1123 illustrates measuring population impedance observation data that indicates a time series of impedance measurements during a population observation time in which a plurality of biological cells of a sample traverses a first gap between a first pair of electrodes in a first microfluidic channel. In step 1225, at least one metric of the impedance extrema, such as peak amplitude or peak width or peak area is determined from the impedance data for the cells from the sample and a PDF of the sample for that metric is formed. Thus step 1225 illustrates generating a measured probability density function of a metric of isolated extrema in the population impedance observation data for the sample.

In step 1227, one or more of the learned PDFs for that metric are combined in various percentages until a good fit is found to the PDF of the metric for the sample and to any a priori knowledge of the tissue from which the sample was taken, e.g., breast or blood. Thus step 1227 includes automatically determining a first cell type in the sample based on the measured probability density function and a database storing a probability density function of values of the metric of isolated extrema in impedance training data for each cell type of a plurality of cell types. The best fit could be a close match to a first cell type PDF and the result is that the sample includes the first cell type. No portion or percentage needs be determined or presented. In step 1229, the percentage or other expression of portion of the sample that is fit by the PDF of the at least one cell type is presented to a user, such as by displaying on a display device or sending in a signal to a device at the location of a user. In some embodiments, step 1227 is performed by a neural network trained to output percentages of each of one or more cell types based on an input distribution of impedance extrema.

In step 1231, it is determined whether there is another sample to analyze. If so, control passes back to step 1221 and following steps to determine the portion of at least one cell type in the next sample based on the learned PDFs. If there is another homogeneous cell type to measure then step 1231 includes returning to step 1201 and following steps to prepare a population of cells for the next cell type and learn the PDF for the metric for that cell type. If there is no other cell type to learn either, then the process ends.

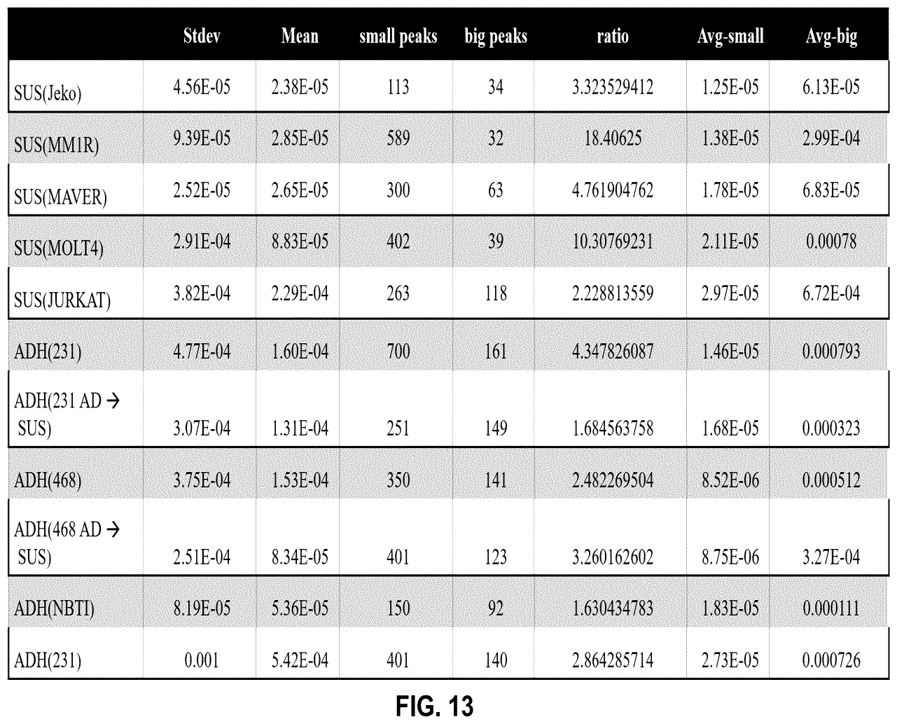

FIG. 13 is a table that illustrates example values of PDF or statistical parameters for impedance extrema metrics of different cell types, according to an embodiment. Each table row includes values for standard deviation (Stdev), mean (average), small peaks (small extrema), big peaks (big extrema), and the ratios and averages of these peaks (extrema). The standard deviation and mean provide insights into the variability and central tendency of the impedance extrema values, respectively. Small peaks represent the count of impedance events below a defined threshold, possibly indicating the passage of extracellular vesicles or smaller cells. Conversely, big peaks count the events where impedance exceeds the threshold, likely representing larger cells. This distinction is advantageous for understanding cell size distribution within samples. For example, as illustrated in FIG. 10A, impedance data vary in magnitude, with some events showing smaller (small peaks) and others larger (big peaks) impedance changes. A threshold was established to classify these events, and the ratio of small to big peaks was calculated to quantify their relative frequencies. The last two columns of the table display the average values of small and big peaks, offering a summary measure of the magnitude of these impedance events. Additionally, the first column differentiates cell types into suspension (SUS) and adherent (ADH), with labels like Jeko, MM1R, MAVER, MOLT4, and Jurkat identifying specific suspension cell types. The notation ‘AD→SUS’ signifies cells transitioning from adherent to suspension state, capturing dynamic changes in cell adhesion properties. This comprehensive analysis allows for a nuanced understanding of cell behavior in microfluidic environments, based on impedance measurements and statistical assessment.

### 4. EXAMPLE EMBODIMENTS

Some example embodiments using the method 800 or the method 1200 are described in greater detail in the her. These embodiments demonstrate both more efficient machine learning with fewer adjustable parameters P, and better performance than previous work in reproducing desired results.

### 4.1 Cell Culture and Preparation

To run cells of interest through an embodiment of a microfluidic device, such as device 310, involves proper cell preparation as explained here, for the variety of cells used in the example embodiment.

Human breast cancer cells, MDA-MB-468 and hematological malignant cells (Suspension cells: JeKo-1; Maver-1; MM-1R; MOLT-4; Jurkat) were cultured in RPMI 1640 medium (Life technologies, Grand Island, NY, catalog number 11875-093-500 mL). Human breast cancer cells, MDA-MB-231 were cultured in the MEM medium (Minimum Essential Medium) (Life technologies, Grand Island, NY, catalog number 32561-037-500). Human cervical cancer cells, HeLa were cultured in the DMEM medium (Dulbecco's Modified Eagle Medium) (Life technologies, Grand Island, NY, catalog number 10569-010-500). Mouse breast cancer cell line, NBT1 (obtained from Bruce G. Haffty Laboratory) were cultured in media composed of CMRL-1066 (Invitrogen, Carlsbad, CA, catalog number 11530-037-500 mL) supplemented with 2 mM L-glutamine and 4 μM Dexamethasone. All the media contained 10% fetal bovine serum (Life Technologies, Grand Island, NY) and 1% penicillin-streptomycin (Life Technologies, Grand Island, NY) and were cultured in an incubator with atmosphere of 5% carbon dioxide and 37° C. All the cell lines were obtained from American Type Culture Collection (ATCC) and were checked for mycoplasma by MycoAlert™ mycoplasma detection kit (Lonza USA) before starting any experiment.

Adherent cells, MDA-MB-468, MDA-MB-231, NBT1 and HeLa were grown in a 100 by 55 mm petri-dish. The cells were analyzed under a microscope to ensure the proper morphology and confluence, followed by the cell viability analysis. Upon reaching to 70-80% confluence, growth media was aspirated, and cells were washed with 1× phosphate-buffered saline (PBS) twice and were detached using 1 mL trypsin (0.25%) for 5-10 minutes in an incubator and collected using 2-3 mL growth media in a 15-mL collection tube. The cells were homogenized with the growth media and cell viability was determined using the Vi-CELL Series Cell Viability Analyzer (Beckman Coulter, Carlsbad, CA). Finally, one million viable cells were re-suspended in 1 mL of 1×PBS after being washed twice with 1×PBS to remove all the growth media components, before being used for the example embodiment.

Suspension cells (JeKo-1; Maver-1; MM-1R; MOLT-4; Jurkat) were grown in a T-75 flask and analyzed under a microscope to ensure the proper morphology and/or confluence, followed by the cell viability analysis. Suspension cells were then collected in a 15-mL collection tube, homogenized with the growth media and cell viability was determined using the Vi-CELL Series Cell Viability Analyzer (Beckman Coulter, Carlsbad, CA). Finally, one million viable cells were re-suspended in 1 mL of 1×PBS after being washed twice with 1×PBS to remove all the growth media components, before being used for the example embodiment.

Adherent cells, MDA-MB-468 and MDA-MB-231 were grown in their respective cell culture growth media and were continued growing them in the overspent growth media (similar to growth factors depleted media) until they become suspension cells, that is when they lost the adherent property. We collected these suspension cells and check their viability and compared it with the adherent ones from the same petri-dish. We called them adherent to suspension (AD>>S) transition cells; in other-words they are isogenic cells, means coming from the same cell line. These viable AD>>S cells were then collected in a 15-mL collection tube, homogenized with the growth media and cell viability was determined using the Vi-CELL Series Cell Viability Analyzer (Beckman Coulter, Carlsbad, CA). Finally, one million viable AD>>S cells were re-suspended in 1 mL of 1×PBS after being washed twice with 1×PBS to remove all the growth media components, before being used for the example embodiment.

### 4.2 Example Generative AI Image Performance

In an example of method 800, a neural network was utilized with 8 hidden layers, comprising 100, 80, 40, 50, 30, 15, 20, and 1000 nodes in each layer, respectively. The input layer consists of 191 nodes, tailored to our specific problem's needs. For the output layer, 2601 nodes were used, which corresponds to the dimensions of a 51 by 51-pixel image, as the output represents an image of this size. In other embodiments, this configuration can be adjusted for different problems, indicating the model's flexibility. For this specific embodiment, the ReLU activation function was used due to its effectiveness in preventing the vanishing gradient problem and its computational efficiency. ReLU's simple yet powerful operation allows for deeper network architectures without compromising on learning speed or accuracy, making it an advantageous choice for this embodiment and demonstrating the thoughtful consideration required in selecting components to optimize neural network performance for specific tasks.

Notably, this embodiment achieved a remarkable 91% accuracy. We analyzed a total of 125 images, with a validation set including 20% of this dataset. A side-by-side comparison of the original and AI generated predicted images shows the accuracy of the AI in replicating the original cell images. To assess the precision of this embodiment, we employed the Structural Similarity Index SSI) and the Mean Structural Similarity Index (MSSIM) on the test dataset. These metrics confirmed the high accuracy of the example embodiment. The results are particularly impressive for breast cancer cells and beads, achieving MSSIM scores of 0.97 and 0.93 respectively in a 25-image validation set. This highlights the high quality of the images reconstructed by the AI compared to the original images.

This example embodiment represents a novel departure from the methods employed by Tripathy et al. [4], who utilized cell images for cancer cell classification. In contrast, the example embodiment approach leverages electrical impedance signals to construct cell images, introducing a pioneering technique in this technology. The method 800 stands out by not only classifying different types of cancer cells but also by being the first to generate images from electrical impedance signals. Not only does the example embodiment incorporate AI in the form of a deep learning model for image reconstruction, it also advances the use of a microfluidic sensor. The deep learning model, designed with eight hidden layers, analyzes not just a single impedance value, but the entire spectrum of the electrical impedance response, capturing 191 distinct values per time series. This enables us to differentiate between cancer cells and beads by identifying their unique impedance signatures at each of one or more frequencies.

This example embodiment represents a major leap in cancer cell imaging and shows the potential of MEMS technology, such as microfluidics device 310, in biomedical applications. Utilizing electrical impedance signals to generate detailed cell images based on AI deep learning, the example embodiment demonstrates a significant departure from conventional imaging techniques.

### 4.3 Example Population Type Performance

Examples of method 1200 enables important distinctions to be made between adherent and suspended cell populations. Adherent cell lines represent the cells which are anchorage-dependent and need a growth substrate for physical attachment for proliferation and survival. Common primary cells, that are harvested from living tissue (for example, tumor tissues) and continuous cell lines including human embryonic kidney cells (HEK293), mesenchymal stem cells, induced pluripotent stem cells (iPSCs) represent adherent cells. In some experimental embodiments, tumor cells collected from lung cancer microenvironment in mice were also used as examples of cells in the suspension stage or the transition stage (from adherent to suspension).

Adherent cells fall into several categories based upon their origin and morphological characteristics, such as nuclei size, cytoplasmic ratio and most importantly shape. For instance, MDA-MB-231 represent basal-type breast cancer with elongated shape and MDA-MB-468 cells are epithelial like in morphology and both cell lines lack hormonal (estrogen, progesterone and human epidermal growth factor receptor 2) receptors, thus represent the triple negative breast cancer cells, epithelial cells exhibit polygonal shape, endothelial cells take ductal fashion and neuronal cells take projection processes.

The visualization of adherent cell's morphology is an important phenotypic characteristic of their cellular biology and function. Adherent cell line culturing provides a more natural environment because it recapitulates the cell-cell and cell-matrix interactions which govern the cell signaling reactions that regulate cellular functions, including cell cycle progression, differentiation and response to growth factors. Anchorage matrix used for adherent cells can be tailored to regulate the specific applications or cell phenotype to achieve. They have high important role for regenerative medicine and tissue engineering, like hiPSCs can produce cardiomyocytes for heart tissue repairs.

Thus, the microfluidic device 310 is capable of differentiating this cell population based upon their electrical properties (impedance) when; a) they are growing fully on anchorage matrix (i.e., are the adherent cells or solid tumors or benign tumors); b) when they lose that anchorage-dependency due to metabolic intervention (adherent to suspension transition) and c) importantly predicts their cell shape, which represents their phenotypic character and function, when integrated the impedance time series is input into the generative Artificial Intelligence neural network of method 800.

On the other hand, suspension cells grow as suspended cells in growth media and do not need growth substrate for attachment. They grow as a single cell or clusters of cells. Hematopoietic cells represent the best example of suspension cells. Suspension cell cultures are dynamic and specific cell concentration, media volume and cell expansion constrain suspension cells growth in addition to the shear stress. Although scalable and highly efficient, the isolation of the dead cells from the viable suspension cell culture need additional steps of processing than the simple washings in case of adherent cell culturing. Monoclonal antibody production for cancer therapy as well as rapid vaccine production is all achieved due to the suspension cell cultures. In our study, suspension cell lines, JeKo-1 and Maver-1 represent mantle cell lymphoma cell lines, Jurkat and Molt-4 represents T-cell acute lymphoblastic leukemia (T-ALL) cells and MM-1R represents the multiple myeloma. Thus, highlights that our study represents most of the hematological malignancies or possible metastatic cells and our device could be used to differentiates these cell type populations based upon their impedance electrical property.

Based upon various experimental embodiments of method 1200, the following comparative impedance statistics (in microvolts, μv) of suspension and adherent cells were observed. The first three cell types are suspension cell types and the last four are adherent cell types.

| | | | | 231 | 468 | | |
|---|---|---|---|---|---|---|---|
| | | | | BREAST | BREAST | | LUNG |
| | JEKO | MM1R | MAVER | CANCER | CANCER | NBT1 | CANCER |
| Mean | 2.51 | 8.71 | 3.47 | 86.7 | 55.7 | 11 | 47.7 |
| (10⁻⁵ μv) | | | | | | | |
| Standard | 4.54 | 18 | 2.79 | 82.1 | 58.7 | 11.9 | 65.8 |
| Deviation | | | | | | | |
| (10⁻⁵ μv) | | | | | | | |
| Median | 1 | 3 | 2 | 63 | 28 | 7 | 11 |
| (10⁻⁵ μv) | | | | | | | |

In general, these observed impedance statistics show that suspension cells have relatively low mean values and small standard deviations. This indicates a more consistent response compared to other cell lines. In contrast, adherent cells have higher mean values and larger standard deviations, indicating greater variability in their response. Thus, these techniques can be used to distinguish suspension cancer samples from adherent cancer samples. Populations of suspension cultures generally exhibit lower mean, variance and median impedance values compared to adherent cultures.

### 5. COMPUTATIONAL HARDWARE OVERVIEW

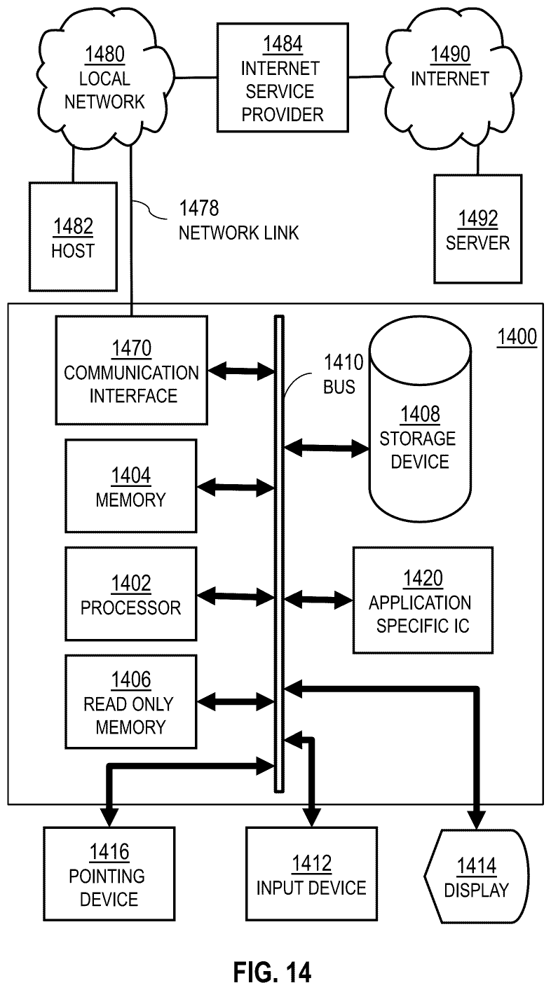

FIG. 14 is a block diagram that illustrates a computer system 1400 upon which an embodiment of the invention may be implemented. Computer system 1400 includes a communication mechanism such as a bus 1410 for passing information between other internal and external components of the computer system 1400. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1400, or a portion thereof, constitutes a means for performing one or more steps of one or more methods described herein.

A sequence of binary digits constitutes digital data that is used to represent a number or code for a character. A bus 1410 includes many parallel conductors of information so that information is transferred quickly among devices coupled to the bus 1410. One or more processors 1402 for processing information are coupled with the bus 1410. A processor 1402 performs a set of operations on information. The set of operations include bringing information in from the bus 1410 and placing information on the bus 1410. The set of operations also typically include comparing two or more units of information, shifting positions of units of information, and combining two or more units of information, such as by addition or multiplication. A sequence of operations to be executed by the processor 1402 constitutes computer instructions.

Computer system 1400 also includes a memory 1404 coupled to bus 1410. The memory 1404, such as a random access memory (RAM) or other dynamic storage device, stores information including computer instructions. Dynamic memory allows information stored therein to be changed by the computer system 1400. RAM allows a unit of information stored at a location called a memory address to be stored and retrieved independently of information at neighboring addresses. The memory 1404 is also used by the processor 1402 to store temporary values during execution of computer instructions. The computer system 1400 also includes a read only memory (ROM) 1406 or other static storage device coupled to the bus 1410 for storing static information, including instructions, that is not changed by the computer system 1400. Also coupled to bus 1410 is a non-volatile (persistent) storage device 1408, such as a magnetic disk or optical disk, for storing information, including instructions, that persists even when the computer system 1400 is turned off or otherwise loses power.

Information, including instructions, is provided to the bus 1410 for use by the processor from an external input device 1412, such as a keyboard containing alphanumeric keys operated by a human user, or a sensor. A sensor detects conditions in its vicinity and transforms those detections into signals compatible with the signals used to represent information in computer system 1400. Other external devices coupled to bus 1410, used primarily for interacting with humans, include a display device 1414, such as a cathode ray tube (CRT) or a liquid crystal display (LCD), for presenting images, and a pointing device 1416, such as a mouse or a trackball or cursor direction keys, for controlling a position of a small cursor image presented on the display 1414 and issuing commands associated with graphical elements presented on the display 1414.

In the illustrated embodiment, special purpose hardware, such as an application specific integrated circuit (IC) 1420, is coupled to bus 1410. The special purpose hardware is configured to perform operations not performed by processor 1402 quickly enough for special purposes. Examples of application specific ICs include graphics accelerator cards for generating images for display 1414, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1400 also includes one or more instances of a communications interface 1470 coupled to bus 1410. Communication interface 1470 provides a two-way communication coupling to a variety of external devices that operate with their own processors, such as printers, scanners and external disks. In general, the coupling is with a network link 1478 that is connected to a local network 1480 to which a variety of external devices with their own processors are connected. For example, communication interface 1470 may be a parallel port or a serial port or a universal serial bus (USB) port on a personal computer. In some embodiments, communications interface 1470 is an integrated services digital network (ISDN) card or a digital subscriber line (DSL) card or a telephone modem that provides an information communication connection to a corresponding type of telephone line. In some embodiments, a communication interface 1470 is a cable modem that converts signals on bus 1410 into signals for a communication connection over a coaxial cable or into optical signals for a communication connection over a fiber optic cable. As another example, communications interface 1470 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 1470 sends and receives electrical, acoustic or electromagnetic signals, including infrared and optical signals, that carry information streams, such as digital data.

The term computer-readable medium is used herein to refer to any medium that participates in providing information to processor 1402, including instructions for execution. Such a medium may take many forms, including, but not limited to, non-volatile media, volatile media and transmission media. Non-volatile media include, for example, optical or magnetic disks, such as storage device 1408. Volatile media include, for example, dynamic memory 1404. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 1402, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 1402, except for carrier waves and other signals.

Logic encoded in one or more tangible media includes one or both of processor instructions on a computer-readable storage media and special purpose hardware, such as ASIC 1420.

Network link 1478 typically provides information communication through one or more networks to other devices that use or process the information. For example, network link 1478 may provide a connection through local network 1480 to a host computer 1482 or to equipment 1484 operated by an Internet Service Provider (ISP). ISP equipment 1484 in turn provides data communication services through the public, world-wide packet-switching communication network of networks now commonly referred to as the Internet 1490. A computer called a server 1492 connected to the Internet provides a service in response to information received over the Internet. For example, server 1492 provides information representing video data for presentation at display 1414.

The invention is related to the use of computer system 1400 for implementing the techniques described herein. According to one embodiment of the invention, those techniques are performed by computer system 1400 in response to processor 1402 executing one or more sequences of one or more instructions contained in memory 1404. Such instructions, also called software and program code, may be read into memory 1404 from another computer-readable medium such as storage device 1408. Execution of the sequences of instructions contained in memory 1404 causes processor 1402 to perform the method steps described herein. In alternative embodiments, hardware, such as application specific integrated circuit 1420, may be used in place of or in combination with software to implement the invention. Thus, embodiments of the invention are not limited to any specific combination of hardware and software.

The signals transmitted over network link 1478 and other networks through communications interface 1470, carry information to and from computer system 1400. Computer system 1400 can send and receive information, including program code, through the networks 1480, 1490 among others, through network link 1478 and communications interface 1470. In an example using the Internet 1490, a server 1492 transmits program code for a particular application, requested by a message sent from computer 1400, through Internet 1490, ISP equipment 1484, local network 1480 and communications interface 1470. The received code may be executed by processor 1402 as it is received, or may be stored in storage device 1408 or other non-volatile storage for later execution, or both. In this manner, computer system 1400 may obtain application program code in the form of a signal on a carrier wave.

Various forms of computer readable media may be involved in carrying one or more sequence of instructions or data or both to processor 1402 for execution. For example, instructions and data may initially be carried on a magnetic disk of a remote computer such as host 1482. The remote computer loads the instructions and data into its dynamic memory and sends the instructions and data over a telephone line using a modem. A modem local to the computer system 1400 receives the instructions and data on a telephone line and uses an infra-red transmitter to convert the instructions and data to a signal on an infra-red a carrier wave serving as the network link 1478. An infrared detector serving as communications interface 1470 receives the instructions and data carried in the infrared signal and places information representing the instructions and data onto bus 1410. Bus 1410 carries the information to memory 1404 from which processor 1402 retrieves and executes the instructions using some of the data sent with the instructions. The instructions and data received in memory 1404 may optionally be stored on storage device 1408, either before or after execution by the processor 1402.

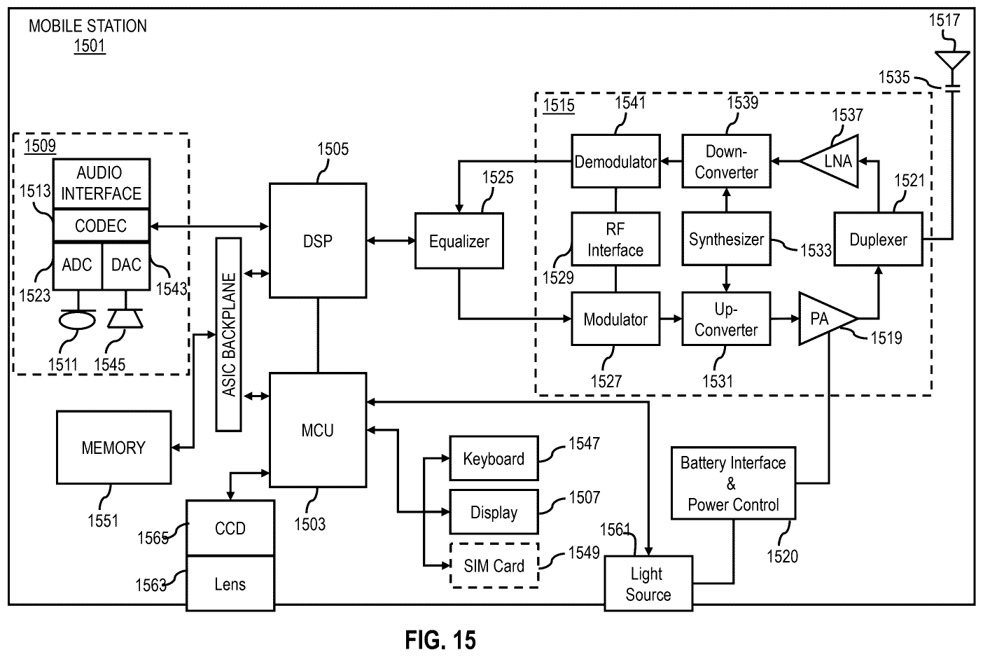

FIG. 15 is a diagram of exemplary components of a mobile terminal 1500 (e.g., cell phone handset) for communications, which is capable of operating in the system of FIG. 3C, according to one embodiment. In some embodiments, mobile terminal 1501, or a portion thereof, constitutes a means for performing one or more steps described herein. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile terminal functions that perform or support the steps as described herein. The display 1507 includes display circuitry configured to display at least a portion of a user interface of the mobile terminal (e.g., mobile telephone). Additionally, the display 1507 and display circuitry are configured to facilitate user control of at least some functions of the mobile terminal. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system, via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile terminal 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1505. A Digital to Analog Converter (DAC) 1543 converts the signal and the resulting output is transmitted to the user through the speaker 1545, all under control of a Main Control Unit (MCU) 1503 which can be implemented as a Central Processing Unit (CPU) (not shown).

The MCU 1503 receives various signals including input signals from the keyboard 1547. The keyboard 1547 and/or the MCU 1503 in combination with other user input components (e.g., the microphone 1511) comprise a user interface circuitry for managing user input. The MCU 1503 runs a user interface software to facilitate user control of at least some functions of the mobile terminal 1501 as described herein. The MCU 1503 also delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the terminal. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile terminal 1501.

The CODEC 1513 includes the ADC 1523 and DAC 1543. The memory 1551 stores various data including call incoming tone data and is capable of storing other data including music data received via, e.g., the global Internet. The software module could reside in RAM memory, flash memory, registers, or any other form of writable storage medium known in the art. The memory device 1551 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1549 carries, for instance, important information, such as the cellular phone number, the carrier supplying service, subscription details, and security information. The SIM card 1549 serves primarily to identify the mobile terminal 1501 on a radio network. The card 1549 also contains a memory for storing a personal telephone number registry, text messages, and user specific mobile terminal settings.

In some embodiments, the mobile terminal 1501 includes a digital camera comprising an array of optical detectors, such as charge coupled device (CCD) array 1565. The output of the array is image data that is transferred to the MCU for further processing or storage in the memory 1551 or both. In the illustrated embodiment, the light impinges on the optical array through a lens 1563, such as a pin-hole lens or a material lens made of an optical grade glass or plastic material. In the illustrated embodiment, the mobile terminal 1501 includes a light source 1561, such as a LED to illuminate a subject for capture by the optical array, e.g., CCD 1565. The light source is powered by the battery interface and power control module 1520 and controlled by the MCU 1503 based on instructions stored or loaded into the MCU 1503.

### 6. ALTERNATIVES, DEVIATIONS AND MODIFICATIONS

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5× to 2×, for example, about 100 implies a value in a range from 50 to 200. Moreover, all ranges disclosed herein are to be understood to encompass any and all sub-ranges subsumed therein. For example, a range of “less than 10” for a positive only parameter can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

### 7. REFERENCES

All these references are hereby incorporated by reference as if fully set forth herein except for terminology inconsistent with that used herein.
1. Kokabi, Mahtab, et al. “Nucleic Acid Quantification by Multi-Frequency Impedance Cytometry and Machine Learning.” Biosensors 13.3 (2023): 316.
2. Javanmard, Mehdi, et al. “Use of multi-frequency impedance cytometry in conjunction with machine learning for classification of biological particles.” U.S. Pat. No. 11,604,133. 14 Mar. 2023.
3. Sui, Jianye, et al. “Multi-frequency impedance sensing for detection and sizing of DNA fragments.” Scientific reports 11.1 (2021): 6490.
4. Tripathy, Rajesh Kumar, Sailendra Mahanta, and Subhankar Paul. “Artificial intelligence-based classification of breast cancer using cellular images.” Rsc Advances 4.18 (2014): 9349-9355
5. Bakurov, Illya, et al. “Structural similarity index (SSIM) revisited: A data-driven approach.” Expert Systems with Applications 189 (2022): 116087.

What is claimed is:

1. A method for imaging a single cell, the method comprising:
measuring single cell impedance observation data that indicates a time series of impedance measurements during an observation time in which a single biological cell traverses a first gap between a first pair of electrodes in a first microfluidic channel;
generating a virtual image of the single cell based on the single cell impedance observation data using a neural network trained on a plurality of training instances, each training instance comprising single cell impedance observation data for a training instance single biological cell and a microscopic image of the training instance single biological cell; and
presenting the virtual image of the single cell on a display device.

2. The method as recited in claim 1, wherein the microscopic image of the training instance single biological cell is a single frame of a microscopic video viewing a second gap between a second pair of electrodes in a second microfluidic channel as the training instance single biological cell traverses the second gap to obtain the single cell impedance observation data for the training instance single biological cell.

3. The method as recited in claim 2, wherein the first gap between the first pair of electrodes in the first microfluidic channel is also the second gap between the second pair of electrodes in the second microfluidic channel.

4. A non-transitory computer-readable medium carrying one or more sequences of instructions for measuring cell dynamics, wherein execution of the one or more sequences of instructions by one or more processors causes the one or more processors to perform the steps of:
retrieving from a computer-readable medium single cell impedance observation data that indicates a plurality of impedance measurements during an observation time in which a single biological cell traverses a first gap between a first pair of electrodes in a first microfluidic channel;
generating a virtual image of the single cell based on the single cell impedance observation data using a neural network trained on a plurality of training instances, each training instance comprising single cell impedance observation data for a training instance single biological cell and a microscopic image of the training instance single biological cell; and
presenting the virtual image of the single cell on a display device.

5. The computer-readable medium as recited in claim 4, wherein the microscopic image of the training instance single biological cell is a single frame of a microscopic video viewing a second gap between a second pair of electrodes in a second microfluidic channel as the training instance single biological cell traverses the second gap to obtain the single cell impedance observation data for the training instance single biological cell.

6. The computer-readable medium as recited in claim 4, wherein the first gap between the first pair of electrodes in the first microfluidic channel is also the second gap between the second pair of electrodes in the second microfluidic channel.

7. An apparatus for imaging a single cell, the apparatus comprising:
at least one processor; and
at least one memory including one or more sequences of instructions,
the at least one memory and the one or more sequences of instructions configured to, with the at least one processor, cause the apparatus to perform at least the following,
retrieving from a computer-readable medium single cell impedance observation data that indicates a plurality of impedance measurements during an observation time in which a single biological cell traverses a first gap between a first pair of electrodes in a first microfluidic channel;
generating a virtual image of the single cell based on the single cell impedance observation data using a neural network trained on a plurality of training instances, each training instance comprising single cell impedance observation data for a training instance single biological cell and a microscopic image of the training instance single biological cell; and
presenting the virtual image of the single cell on a display device.

8. The apparatus as recited in claim 7, wherein the microscopic image of the training instance single biological cell is a single frame of a microscopic video viewing a second gap between a second pair of electrodes in a second microfluidic channel as the training instance single biological cell traverses the second gap to obtain the single cell impedance observation data for the training instance single biological cell.

9. The apparatus as recited in claim 7, wherein the first gap between the first pair of electrodes in the first microfluidic channel is also the second gap between the second pair of electrodes in the second microfluidic channel.

10. A system for imaging a single cell, the apparatus comprising:
the apparatus of claim 7;
a microfluidic device comprising the first gap between the first pair of electrodes in the first microfluidic channel; and
an impedance measurement circuit.

11. The system as recited in claim 10, wherein the microscopic image of the training instance single biological cell is a single frame of a microscopic video viewing a second gap between a second pair of electrodes in a second microfluidic channel as the training instance single biological cell traverses the second gap to obtain the single cell impedance observation data for the training instance single biological cell.

12. The system as recited in claim 10, wherein the first gap between the first pair of electrodes in the first microfluidic channel is also the second gap between the second pair of electrodes in the second microfluidic channel.

13. A method for automatically determining cell type of a population of biological cells in a sample, the method comprising:
measuring population impedance observation data that indicates a time series of impedance measurements during a population observation time in which a plurality of biological cells of a sample traverses a first gap between a first pair of electrodes in a first microfluidic channel;
generating a measured probability density function of a metric of isolated extrema in the population impedance observation data for the sample;
automatically determining a first cell type in the sample based on the measured probability density function and a database storing a probability density function of values of the metric of isolated extrema in impedance training data for each cell type of a plurality of cell types; and
presenting the first cell type.

14. The method as recited in claim 13, further comprising:
determining a first portion of the sample contributed by the first cell type; and
presenting the first portion.

15. A non-transitory computer-readable medium carrying one or more sequences of instructions for measuring cell dynamics, wherein execution of the one or more sequences of instructions by one or more processors causes the one or more processors to perform the steps of:
retrieving from a computer-readable medium population impedance observation data that indicates a time series of impedance measurements during a population observation time in which a plurality of biological cells of a sample traverses a first gap between a first pair of electrodes in a first microfluidic channel;
generating a measured probability density function of amplitudes of isolated extrema in the population impedance observation data for the sample;
automatically determining a first cell type in the sample based on the measured probability density function and a database storing a probability density function of amplitudes of isolated extrema in impedance training data for each cell type of a plurality of cell types; and
presenting the first cell type.

16. The computer-readable medium as recited in claim 15, wherein the instructions further cause the one or more processors to perform:
determining a first portion of the sample contributed by the first cell type; and
presenting the first portion.

17. An apparatus for automatically determining cell type of a population of biological cells in a sample, the apparatus comprising:
at least one processor; and
at least one memory including one or more sequences of instructions,
the at least one memory and the one or more sequences of instructions configured to, with the at least one processor, cause the apparatus to perform at least the following,
retrieving from a computer-readable medium population impedance observation data that indicates a time series of impedance measurements during a population observation time in which a plurality of biological cells of a sample traverses a first gap between a first pair of electrodes in a first microfluidic channel;
generating a measured probability density function of amplitudes of isolated extrema in the population impedance observation data for the sample;
automatically determining a first cell type in the sample based on the measured probability density function and a database storing a probability density function of amplitudes of isolated extrema in impedance training data for each cell type of a plurality of cell types; and
presenting the first cell type.

18. The apparatus as recited in claim 17, wherein the instructions further causes the one or more processors to perform:
determining a first portion of the sample contributed by the first cell type; and
presenting the first portion.

19. A system for automatically determining cell type of a population of biological cells in a sample, the apparatus comprising:
the apparatus of claim 17;
a microfluidic device comprising the first gap between the first pair of electrodes in the first microfluidic channel; and
an impedance measurement circuit.

20. The system as recited in claim 19, wherein the instructions further causes the one or more processors to perform:
determining a first portion of the sample contributed by the first cell type; and
presenting the first portion.
